(19) United States
(12) Patent Application Publication
(10) Pub. No.: US 2019/0379015 A1
(43) Pub. Date: Dec. 12, 2019

(54) POWER SOURCE DEVICE

(71) Applicant: SANYO Electric Co., Ltd., Daito-shi, Osaka (JP)

(72) Inventors: Shingo Ochi, Hyogo (JP); Hideaki Yano, Hyogo (JP)

(73) Assignee: SANYO Electric Co., Ltd., Daito-shi, Osaka (JP)

(21) Appl. No.: 16/481,249

(22) PCT Filed: Jan. 19, 2018
(86) PCT No.: PCT/JP2018/001514

§ 371 Date: Jul. 26, 2019

(30) Foreign Application Priority Data
Jan. 30, 2017 (JP) 2017-014388

(51) Int. Cl. H01M 2/10; H01M 2/20

(52) U.S. Cl. CPC H01M 2/1077; H01M 2/206

(57) ABSTRACT

A power source device includes: a battery stack including a plurality of stacked battery cells each provided with positive and negative electrode terminals; and a bus bar connected to the electrode terminals of the plurality of battery cells to connect the plurality of battery cells in parallel and in series. The bus bar includes a series connection line connecting in series parallel battery groups each including the plurality of battery cells connected in parallel, and a branched connection part branched and connected to each of both ends of the series connection line, in which the electrode terminals of the plurality of battery cells configuring each of the parallel battery groups are connected to the branched connection part to allow the battery cells configuring the parallel battery group to be connected in parallel via the branched connection part.

### TECHNICAL FIELD

The present invention relates to a power source device including a plurality of battery cells connected via a metal plate, and particularly relates to a power source device most appropriate as a power source of a motor configured to drive an electrically driven vehicle like a hybrid vehicle, a fuel cell vehicle, an electric vehicle, or an electric motorcycle, or as a heavy current power source applied for power storage for household use or plant use, or the like.

### BACKGROUND ART

A power source device can have high output voltage with a large number of battery cells connected in series, or large charge and discharge current with a large number of battery cells connected in parallel. A power source device having high output power and applied as a power source of a motor for automobile vehicle travel or the like includes a plurality of battery cells connected in series to have high output voltage. There has also been developed a power source device including a plurality of battery cells connected in parallel and in series to have high output voltage as well as large charge and discharge current.

A power source device including a large number of battery cells connected in parallel and in series is configured to charge and discharge at large current. The battery cells thus include electrode terminals connected via bus bars each made of a metal plate having small electric resistance. For example, a battery stack includes stacked rectangular batteries each having a rectangular outer can (=case, or tin), and electrode terminals of the battery cells adjacent to each other are connected via a bus bar having an elongated strip shape.

### CITATION LIST

### Patent Literatures

PTL 1: Unexamined Japanese Patent Publication No. 2015-187913

PTL 2: WO2014/064888

### SUMMARY OF THE INVENTION

### Technical Problems

FIG. 24 depicts a power source device according to a modification example previously filed by the applicant of the present application (see FIG. 7 in PTL 1). This power source device includes twelve battery cells 101 stacked in a thickness direction to configure battery stack 110, in which four sets of three battery cells 101 connected in parallel are connected in series to have twelve battery cells 101 including four sets connected in series of three battery cells connected in parallel. Battery stack 110 includes each of the sets of three battery cells 101 aligned in the same postures, and the sets are inverted alternately to be stacked. In the power source device, three battery cells 101 aligned in the same postures include electrode terminals 102 opposing each other and connected via bus bar 103 to achieve parallel connection of battery cells 101, and the sets of battery cells 101 adjacent to each other are connected via bus bar 103 to achieve series connection. Bus bar 103 in FIG. 24 has six through holes 104 for connection of electrode terminals 102 of battery cells 101, provided at equal intervals in a length direction of a metal plate having a strip shape, to achieve connection of electrode terminals 102 of six battery cells 101.

The power source device thus configured has a heavy current flow at a portion where the plurality of battery cells 101 is connected in series, and thus needs to reduce electric resistance at such a series connection portion. For example, bus bar 103 depicted in FIG. 24 for connection of six battery cells 101 including two sets connected in series of three battery cells connected in parallel has regions A each having a flow of current to single battery cell 101, regions B each having a flow of the sum of current to two battery cells 101, and region C having a flow of the sum of current to three battery cells 101. Assuming that regions A each have a current flow of 300 A, regions B will each have a current flow of 600 A and region C will have a current flow of 900 A. Bus bar 103 thus needs to have thickness and width adjusted to reduce electric resistance, so as to allow current of at most 900 A. The battery stack has an upper surface provided with the bus bars and other members. The bus bars are thus restricted in width. Such bus bars need to be increased in thickness for reduction in electric resistance. Increase in width of the bus bars needs increase in welding energy and increase in welding time for welding with the electrode terminals, failing to achieve mass production at low cost. Furthermore, increase in heat input for welding may adversely affect the battery cells. Moreover, the bus bars formed to be entirely thick will lead to cost increase due to increase in amount of required metal, as well as increase in weight.

FIG. 25 depicts another power source device according to a modification example previously filed by the applicant of the present application (see FIG. 12 in PTL 2). This power source device includes twelve battery cells 201 stacked in a thickness direction to configure battery stack 210, in which six sets of two battery cells 201 connected in parallel are connected in series to have twelve battery cells 201 including six sets connected in series of two battery cells connected in parallel. Battery stack 210 includes each of the sets of two battery cells 201 aligned in the same postures, and the sets are inverted alternately to be stacked. In the power source device, two battery cells 201 aligned in the same postures include electrode terminals 202 opposing each other and connected via single bus bar 203A to achieve parallel connection of battery cells 201, and the sets of battery cells 201 adjacent to each other are connected via another bus bar 203B to achieve series connection. Bus bars 203A, 203B in FIG. 25 each have cut-away part 205 provided at each end of a metal plate to guide an electrode terminal for connection of electrode terminals 202 of two battery cells 201 adjacent to each other, and electrode terminals 202 are welded at cut-away parts 205.

The power source device thus configured includes bus bars 203A, 203b individually connected at a parallel connection portion between adjacent battery cells 201 and at a series connection portion between the adjacent sets of battery cells 201, respectively. It is accordingly easy to design thinned bus bar 203A for the parallel connection portion and thickened bus bar 203B for the series connection portion. The series connection portion still has the above problems kept unsolved due to increase in thickness of the bus bar.

This power source device includes bus bars 203A, 203B individually connected at the parallel connection portion and the series connection portion. Power supply from the power source device will be stopped if a welded portion of bus bar 203B for the series connection portion is detached. In this case, the power source device mounted on a vehicle will have stopped power supply to a motor and stopped travel with use of the motor.

The present invention has been achieved in view of such backgrounds, and has an object to provide a power source device including a less expensive and light bus bar and reliably allow maximum current flowing to the bus bar connecting a plurality of battery cells in parallel and in series for achievement of safe use.

### Solution to Problems and Advantageous Effects of Invention

A power source device according to an exemplary embodiment of the present invention includes: battery stack 10, 20, 30, 40, 50, 60 including a plurality of stacked battery cells 1 each provided with positive and negative electrode terminals 2; and bus bar 3, 23, 33, 43, 53, 63 connected to electrode terminals 2 of the plurality of battery cells 1 to connect the plurality of battery cells 1 in parallel and in series, the plurality of battery cells 1 being connected in parallel and in series via bus bar 3, 23, 33, 43, 53, 63. Bus bar 3, 23, 33, 43, 53, 63 includes series connection line 5, 25, 35, 45, 55, 65 connecting in series parallel battery groups 9, 29, 39, 49, 59, 69 each including the plurality of battery cells 1 connected in parallel, and branched connection part 4, 24, 34, 44, 54, 64 branched and connected to both ends of series connection line 5, 25, 35, 45, 55, 65. In the power source device, electrode terminals 2 of the plurality of battery cells 1 configuring each of parallel battery groups 9, 29, 39, 49, 59, 69 are connected to branched connection part 4, 24, 34, 44, 54, 64 to allow battery cells 1 configuring parallel battery group 9, 29, 39, 49, 59, 69 to be connected in parallel via branched connection part 4, 24, 34, 44, 54, 64, and battery cells 1 connected in parallel via branched connection part 4, 24, 34, 44, 54, 64 in parallel battery groups 9, 29, 39, 49, 59, 69 are connected in series via series connection line 5, 25, 35, 45, 55, 65.

The power source device according to the present invention includes the less expensive and light bus bar and reliably allows maximum current flowing to the bus bar connecting the plurality of battery cells in parallel and in series for achievement of safe use. It is because the power source device according to the present invention includes the bus bar having the series connection line connecting in series the parallel battery groups each including the plurality of battery cells connected in parallel, and the branched connection part branched and connected to the both ends of the series connection line, the electrode terminals of the plurality of battery cells configuring each of the parallel battery groups are connected in parallel via the branched connection part, and the battery cells in the parallel battery group connected in parallel via the branched connection part are connected in series via the series connection line.

In the power source device according to the present invention, optionally, bus bar 3, 43, 53, 63 includes a plurality of series connection lines 5, 45, 55, 65, series connection lines 5, 45, 55, 65 have both ends connected to each other, and a plurality of branched connection parts 4, 44, 54, 64 is connected to the both ends of series connection lines 5, 45, 55, 65 connected to each other.

In the power source device according to the present invention, optionally, bus bar 3, 43, 53, 63 includes two series connection lines 5, 45, 55, 65.

In the power source device according to the present invention, optionally, branched connection part 4, 24, 44, 64 includes a plurality of terminal connection parts 6, 26, 46, 66 connected to electrode terminals 2 of battery cells 1, and multiple connection part 7, 27, 47, 67 connecting terminal connection parts 6, 26, 46, 66, the both ends of series connection line 5, 25, 45, 65 are connected to multiple connection part 7, 27, 47, 67, and multiple connection part 7, 27, 47, 67 is branched and connected to the plurality of terminal connection parts 6, 26, 46, 66.

In the power source device according to the present invention, optionally, branched connection part 34, 54 includes first branched connection part 34X, 54X having a plurality of terminal connection parts 36, 56 connected to electrode terminals 2 of battery cells 1, and multiple connection part 37, 57 connecting terminal connection parts 36, 56, and second branched connection part 34Y, 54Y having both ends connected to multiple connection part 37, 57 of first branched connection part 34X, 54X and an intermediate part connected to series connection line 35, 55, and the plurality of battery cells 1 connected in parallel via first branched connection part 34X, 54X is connected in parallel via second branched connection part 34Y, 54Y to configure parallel battery group 39, 59.

This configuration achieves the plurality of battery cells including sets connected in series of four or more battery cells connected in parallel.

In the power source device according to the present invention, optionally, second branched connection part 34Y, 54Y is configured by a metal plate thicker than terminal connection part 36, 56, and series connection line 35, 55 is configured by a metal plate lager in transverse sectional area than second branched connection part 34Y, 54Y.

This configuration reduces electric resistance at a series connection portion for the plurality of battery cells to reliably allow maximum current flowing to the bus bar for achievement of safe use.

In the power source device according to the present invention, optionally, terminal connection part 6, 26, 36, 46, 56, 66 is configured by a metal plate thinner than series connection line 5, 25, 35, 45, 55, 65.

This configuration enables the electrode terminal of the battery cell to be reliably welded to the terminal connection part with small welding energy.

In the power source device according to the present invention, optionally, series connection line 25, 35, 45, 65 is configured by first metal plate 21, 31, 41, 61, branched connection part 24, 34, 44, 64 is configured by second metal plate 22, 32, 42, 62, and first metal plate 21, 31, 41, 61 has each end connected to second metal plate 22, 32, 42, 62 and each of the ends of series connection line 25, 35, 45, 65 is connected to branched connection part 24, 34, 44, 64.

The branched connection part and the series connection line are provided as separate members as described above to achieve simple and easy production even in a case where the branched connection part and the series connection line each have a complicated shape. Furthermore, the branched connection part and the series connection line can have easily adjusted electric resistance. In particular, the branched connection part and the series connection line may be made of different metals for adjustment of electric resistance.

In the power source device according to the present invention, optionally, first metal plate 61 includes a plurality of series connection lines 65 having both ends connected, and first metal plate 61 has each end connected to second metal plate 62.

In the power source device according to the present invention, optionally, first metal plate 21, 31, 41, 61 is disposed in a vertical posture or a horizontal posture.

In the power source device according to the present invention, optionally, first metal plate 21, 31, 41, 61 is thicker than second metal plate 22, 32, 42, 62.

### BRIEF DESCRIPTION OF DRAWINGS

FIG. 1 is a schematic perspective view of a power source device according to a first exemplary embodiment of the present invention.

FIG. 2 is an exploded perspective view of the power source device depicted in FIG. 1.

FIG. 3 is an exploded perspective view depicting a coupling structure between battery cells and bus bars.

FIG. 4 is an enlarged sectional view taken along line IV-IV indicated in FIG. 1 and depicting the coupling structure between the battery cells and the bus bar.

FIG. 5 is an enlarged perspective view of the bus bar depicted in FIG. 3.

FIG. 6 is a schematic perspective view of a power source device according to a second exemplary embodiment of the present invention.

FIG. 7 is an exploded perspective view of the power source device depicted in FIG. 6.

FIG. 8 is an exploded perspective view of a bus bar depicted in FIG. 7.

FIG. 9 is a schematic perspective view of a power source device according to a third exemplary embodiment of the present invention.

FIG. 10 is an exploded perspective view of the power source device depicted in FIG. 9.

FIG. 11 is an exploded perspective view of a bus bar depicted in FIG. 10.

FIG. 12 is a schematic perspective view of a power source device according to a fourth exemplary embodiment of the present invention.

FIG. 13 is an exploded perspective view of the power source device depicted in FIG. 12.

FIG. 14 is an exploded perspective view of a bus bar depicted in FIG. 13.

FIG. 15 is a schematic perspective view of a power source device according to a fifth exemplary embodiment of the present invention.

FIG. 16 is an exploded perspective view of the power source device depicted in FIG. 15.

FIG. 17 is an exploded perspective view of a bus bar depicted in FIG. 16.

FIG. 18 is a schematic perspective view of a power source device according to a sixth exemplary embodiment of the present invention.

FIG. 19 is an exploded perspective view of the power source device depicted in FIG. 18.

FIG. 20 is an exploded perspective view of a bus bar depicted in FIG. 19.

FIG. 21 is a block diagram exemplarily depicting a hybrid vehicle configured to travel with use of an engine and a motor and equipped with a power source device.

FIG. 22 is a block diagram exemplarily depicting an electric vehicle configured to travel with use of only a motor and equipped with a power source device.

FIG. 23 is a block diagram exemplifying application to a power source device for power storage.

FIG. 24 is a schematic plan view depicting an exemplary power source device including a plurality of battery cells connected in parallel and in series.

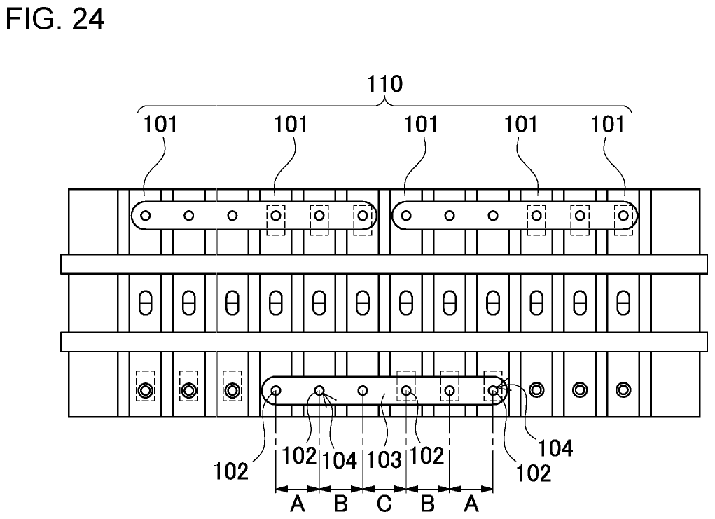

FIG. 25 is a schematic plan view depicting another exemplary power source device including a plurality of battery cells connected in parallel and in series.

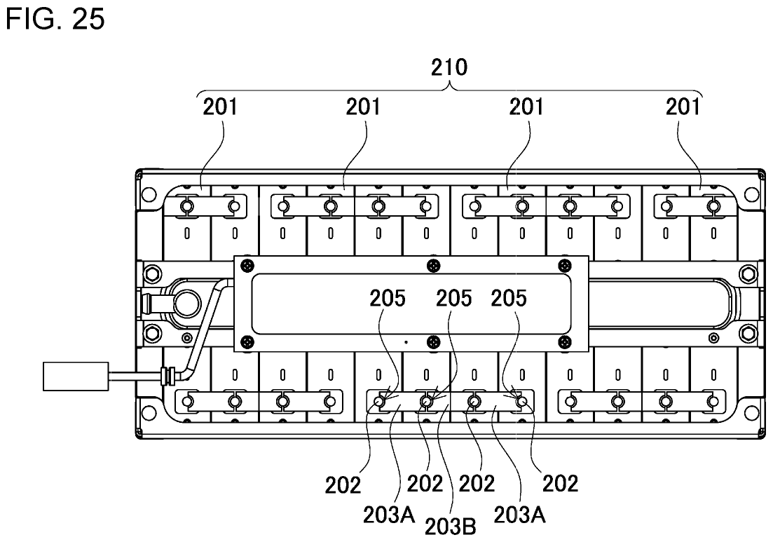

### DESCRIPTION OF EMBODIMENTS

Exemplary embodiments of the present invention will be described hereinafter with reference to the drawings. The following exemplary embodiments are exemplified for achievement of the technical idea of the present invention that is not limited to the exemplary embodiments. The present description should never limit members recited in the claims to members according to the exemplary embodiments. In particular, unless otherwise specified, sizes, materials, shapes, relative disposition, and the like of constituent elements described in the exemplary embodiments are not intended to limit the scope of the present invention but are merely exemplified explanatorily. Members depicted in the drawings may emphasize sizes, positional relations, and the like for clearer depiction. The following description includes identical names or reference marks indicating identical or similar members that will not be described in detail where appropriate. The present invention may provide a plurality of elements configured by an identical member also serving as the plurality of elements, and a single member having a function divisionally achieved by a plurality of members.

The present invention provides a power source device used as a power source applicable to various purposes and particularly appropriate for high power or heavy current, like a power source mounted on an electrically driven vehicle such as a hybrid vehicle or an electric vehicle and configured to supply a drive motor with electric power, a power source configured to store electric power generated from natural energy through solar power generation or wind power generation, or a power source configured to store midnight power.

### (First Exemplary Embodiment)

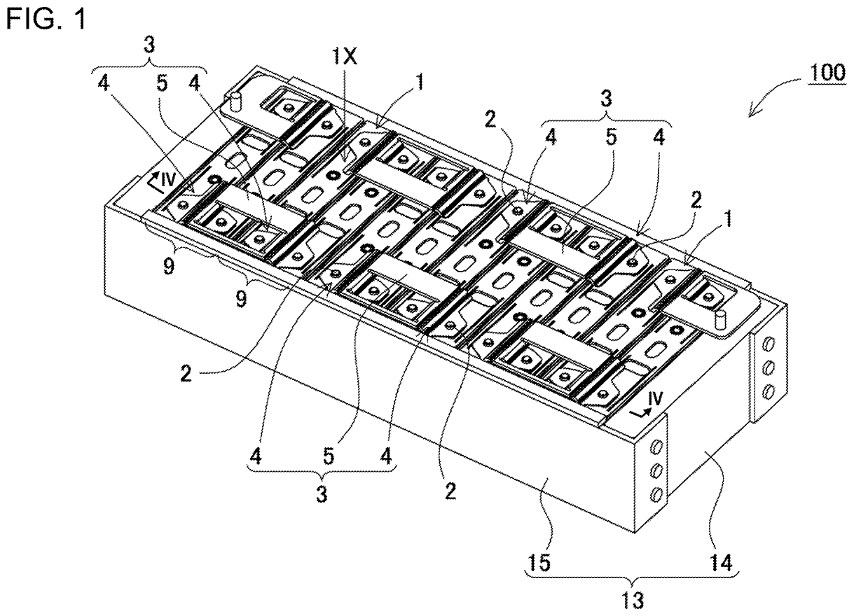

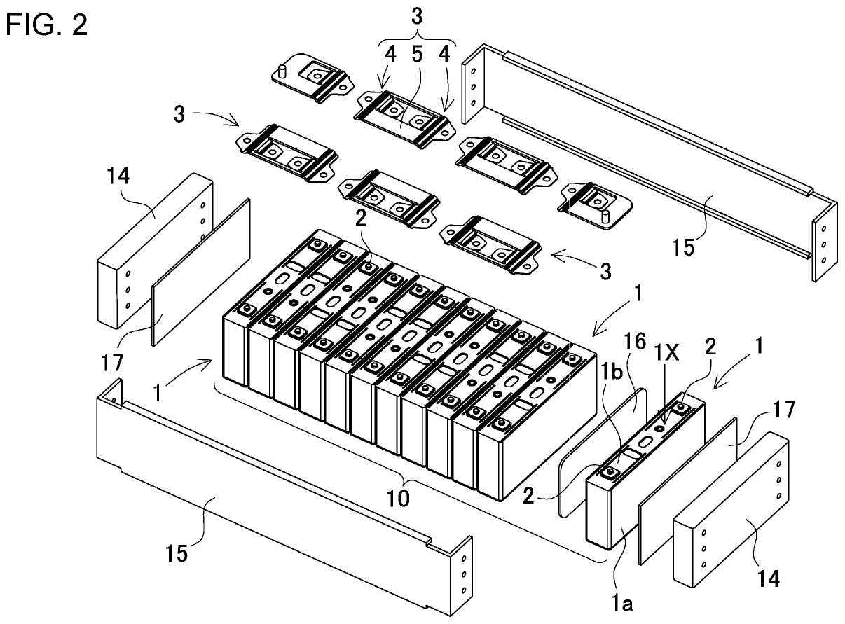

FIG. 1 and FIG. 2 are a perspective view and an exploded perspective view, respectively, of power source device 100 according to a first exemplary embodiment of the present invention. Power source device 100 depicted in FIG. 1 and FIG. 2 includes a plurality of battery cells 1 each provided with positive and negative electrode terminals 2, and bus bars 3 connecting the plurality of battery cells 1 in parallel and in series, and the plurality of battery cells 1 is connected in parallel and in series via bus bars 3. Power source device 100 includes a plurality of parallel battery groups 9 each configured by the plurality of battery cells 1 connected in parallel, and the plurality of parallel battery groups 9 is connected in series to connect the large number of battery cells 1 in parallel and in series. Power source device 100 depicted in FIG. 1 and FIG. 2 includes the plurality of battery cells 1 stacked to configure battery stack 10 fixed by fixture 13 so as to fix the plurality of stacked battery cells 1. Fixture 13 includes a pair of end plates 14 disposed at both end surfaces of stacked battery cells 1, and fasteners 15 coupling ends of end plates 14 to fix stacked battery cells 1 in a pressurized state.

### (Battery Cell 1)

Each of battery cells 1 is configured by a rectangular battery provided with a main wide surface having a rectangular outer shape to have thickness less than width. Battery cell 1 is a secondary battery configured to charge and discharge electric power, and is embodied by a lithium ion secondary battery. Battery cells 1 in the power source device according to the present invention should not be limited to such rectangular batteries or lithium ion secondary batteries. Each of battery cells 1 may alternatively be embodied by any rechargeable battery such as a nonaqueous electrolyte secondary battery other than the lithium ion secondary battery, or a nickel-hydrogen battery cell.

Battery cell 1 includes an electrode assembly having stacked positive and negative electrode plates, and outer can (=case, or tin) 1a accommodating the electrode assembly, filled with an electrolyte, and airtightly closed. Outer can 1a is a rectangular tube having a closed bottom and an upper opening airtightly closed with sealing plate 1b configured by a metal plate. Outer can 1a is produced by deep drawing a metal plate made of aluminum, an aluminum alloy, or the like. Sealing plate 1b is configured by a metal plate made of aluminum, an aluminum alloy, or the like, similarly to outer can 1a. Sealing plate 1b is inserted to the opening of outer can 1a and is airtightly fixed to outer can 1a by laser welding of applying laser beams to a boundary between an outer periphery of sealing plate 1b and an inner periphery of outer can 1a.

### (Electrode Terminal 2)

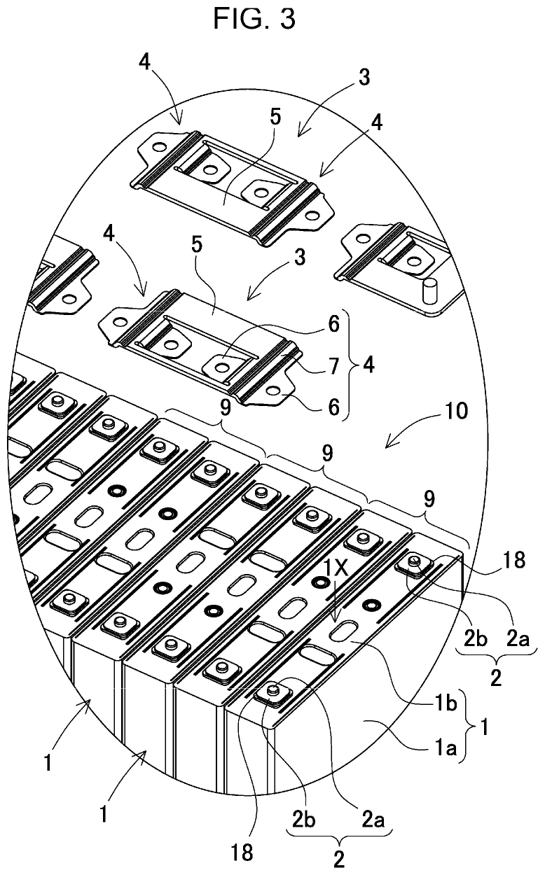

Battery cell 1 has terminal surface 1X configured by sealing plate 1b at the top and having both ends fixing positive and negative electrode terminals 2. As depicted in FIG. 3, positive and negative electrode terminals 2 are fixed to sealing plate 1b via insulating materials 18 and are connected to the incorporated positive and negative electrode plates (not depicted). Positive and negative electrode terminals 2 each have projection 2a and welding surface 2b surrounding projection 2a. Welding surface 2b has a flat shape in parallel with a surface of sealing plate 1b, and projection 2a is disposed at a center of welding surface 2b. Electrode terminals 2 depicted in FIG. 3 each include projection 2a having a columnar shape. The projection may not necessarily have the columnar shape but may alternatively have a polygonal columnar shape or an elliptical columnar shape, though not depicted.

Positive and negative electrode terminals 2 fixed to sealing plate 1b of battery cell 1 are positioned to be bilaterally symmetrical with each other. Battery cells 1 are bilaterally inverted to be stacked and positive and negative electrode terminals 2 adjacent to each other are connected by bus bar 3 to achieve series connection between battery cells 1 adjacent to each other.

### (Battery Stack 10)

The plurality of battery cells 1 is stacked to have a thickness direction in parallel with a stacking direction and configure battery stack 10. The plurality of battery cells 1 in battery stack 10 is stacked such that terminal surfaces 1X provided with positive and negative electrode terminals 2, that is, sealing plates 1b in FIG. 2, are flush with each other.

As depicted in FIG. 2, battery stack 10 includes insulating spacers 16 interposed between stacked battery cells 1. Each of insulating spacers 16 in FIG. 2 is made of an insulating material such as resin and has a thin plate shape or a sheet shape. Insulating spacers 16 in FIG. 2 each have a plate shape substantially equal in size to opposite surfaces of battery cells 1, and are interposed between adjacent battery cells 1 to insulate adjacent battery cells 1. Each of such spacers disposed between adjacent battery cells 1 may alternatively have a flow path for cooling gas between battery cells 1 and the spacer. Still alternatively, battery cells 1 may have surfaces coated with an insulating material. Surfaces of the outer can excluding portions provided with the electrodes of the battery cells may be thermally welded with a shrink tube made of polyethylene terephthalate (PET) resin or the like. Insulating spacers 16 may not be provided in this case. The power source device according to the present invention includes the plurality of battery cells having multiple sets connected in series of multiple battery cells connected in parallel. Insulating spacers 16 are interposed between the battery cells connected in series, but the battery cells connected in parallel may not be provided with any insulating spacers because the adjacent outer cans have no difference in voltage.

Power source device 100 depicted in FIG. 2 further includes end plates 14 disposed at both end surfaces of battery stack 10 with end surface spacers 17 being interposed. As depicted in FIG. 2, end surface spacers 17 are each disposed between battery stack 10 and end plate 14 to insulate end plate 14 from battery stack 10. Each of end surface spacers 17 is made of an insulating material such as resin and has a thin plate shape or a sheet shape. Each of end surface spacers 17 in FIG. 2 is sized and shaped to entirely cover the opposite surface of rectangular battery cell 1 and is interposed between battery cell 1 at each end of battery stack 10 and end plate 14.

In battery stack 10, positive and negative electrode terminals 2 of adjacent battery cells 1 are connected to metal bus bars 3 via which the plurality of battery cells 1 is connected in parallel and in series. In battery stack 10, the plurality of battery cells 1 connected in parallel to configure parallel battery group 9 is stacked such that positive and negative electrode terminals 2 at the both ends of terminal surfaces 1X are aligned bilaterally unidirectionally, whereas battery cells 1 configuring parallel battery groups 9 connected in series are stacked such that positive and negative electrode terminals 2 at the both ends of terminal surfaces 1X are inverted bilaterally. Power source device 100 according to the first exemplary embodiment depicted in FIG. 2 includes twelve battery cells 1 stacked in the thickness direction to configure battery stack 10, in which two battery cells 1 are connected in parallel to configure parallel battery group 9 and six parallel battery groups 9 are connected in series to have twelve battery cells 1 including six sets connected in series of two battery cells s connected in parallel. In battery stack 10 depicted in FIG. 2, two battery cells configuring parallel battery group 9 are stacked such that positive and negative electrode terminals 2 are aligned bilaterally unidirectionally and six parallel battery groups 9 each including two battery cells 1 stacked unidirectionally are stacked such that positive and negative electrode terminals 2 are alternately inverted bilaterally. The present invention should not limit the number and connection states of battery cells 1 configuring battery stack 10. The number and the connection states of the battery cells configuring the battery stack may be modified in various manners, inclusive of other exemplary embodiments to be described later.

The power source device according to the present invention includes battery stack 10 provided with the plurality of stacked battery cells 1, and electrode terminals 2 of the plurality of battery cells 1 adjacent to each other are connected via bus bars 3 to connect the plurality of battery cells 1 in parallel and in series. The present invention provides bus bars 3 connecting electrode terminals 2 of the plurality of battery cells 1 in a predetermined connection state and having a unique structure. Bus bars 3 will be described in detail below in terms of the structure with reference to FIG. 3 to FIG. 5.

The drawings depicting the power source device according to any one of the exemplary embodiments of the present invention exclude a bus bar holder disposing the plurality of bus bars at fixed positions, for clearer depiction of the connection state between the battery cells and the bus bars. The power source device includes the bus bar holder disposed between the battery stack and the bus bars to insulate the plurality of bus bars from each other, insulate the terminal surfaces of the battery cells from the bus bars, and dispose the plurality of bus bars at the fixed positions on an upper surface of the battery stack. Such a bus bar holder may include a holder body having an inner space provided with the plurality of bus bars and divided into a plurality of portions serving as divisional chambers for the bus bars. This bus bar holder is made of an insulating material such as plastic and allows the plurality of bus bars to be fitted at the fixed positions to insulate the electrode terminals having potential difference and dispose the plurality of bus bars at the fixed positions on the upper surface of the battery stack.

### (Bus Bar 3)

Bus bars 3 connect opposite electrode terminals 2 of battery cells 1 disposed adjacent to each other in the plurality of battery cells 1 stacked to be arrayed predeterminedly, to connect the large number of battery cells 1 in parallel and in series. Bus bars 3 depicted in FIG. 1 to FIG. 4 are disposed on an upper surface of battery stack 10 to oppose terminal surfaces 1X of battery cells 1, and substantially linearly connect the plurality of electrode terminals 2 arrayed in the stacking direction of the plurality of battery cells 1 at both sides of battery stack 10. Bus bar 3 includes series connection line 5 connecting in series parallel battery groups 9 each including the plurality of battery cells 1 connected in parallel, and branched connection parts 4 branched and connected to both ends of series connection line 5. Bus bar 3 in the drawings includes a pair of branched connection parts 4 coupled to the both ends of series connection line 5. Branched connection parts 4 of bus bar 3 are each connected to electrode terminals 2 of the plurality of battery cells 1 configuring parallel battery group 9 to connect in parallel battery cells 1 via branched connection part 4. Bus bar 3 connects in series, via series connection line 5, battery cells 1 connected in parallel via branched connection part 4 to configure each parallel battery group 9, to connect in parallel and in series the plurality of battery cells 1 configuring battery stack 10.

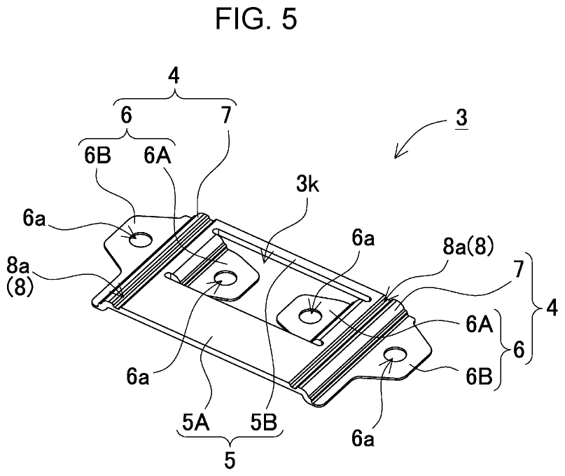

Bus bar 3 is produced by cutting and processing a metal plate to have a predetermined shape. The metal plate configuring bus bar 3 may be made of a metal having small electric resistance and light weight, such as aluminum, copper, or any one of alloys of such metals. The metal plate configuring the bus bar may alternatively be made of any other metal or an alloy of the metal having small electric resistance and light weight. Bus bar 3 depicted in FIG. 5 includes series connection line 5 and branched connection parts 4 integrally configured by a single metal plate. Bus bar 3 is obtained by pressing the single metal plate to integrally form series connection line 5 and branched connection parts 4 having predetermined shapes. This structure allows bus bar 3 including series connection line 5 and branched connection parts 4 to be formed simply and easily. As to be described in detail later, the bus bar may alternatively be configured by a plurality of metal plates to provide the series connection line and the branched connection parts as members separate from each other.

### (Series Connection Line 5)

Series connection line 5 has the both ends coupled to branched connection parts 4 to connect in series the plurality of parallel battery groups 9. Series connection line 5 connects in series sets of the plurality of battery cells 1 connected in parallel via branched connection parts 4. Series connection line 5 has a flow of current corresponding to the sum of current flowing to the plurality of battery cells 1 branched at branched connection parts 4 and connected in parallel. Series connection line 5 is thus determined in terms of the material and the shape to have electric resistance allowing the sum of the current flowing to the plurality of battery cells 1 connected in parallel. The metal plate configuring series connection line 5 has thickness and width most appropriately sized in consideration of maximum current to flow. Bus bar 3 connecting the plurality of battery cells 1 including multiple sets connected in series of two battery cells connected in parallel has series connection line 5 exemplarily configured by a metal plate having 1 mm to 3 mm in thickness and 1 cm to 3 cm in lateral width to have a transverse sectional area of 30 mm² to 60 mm². The present description refers to transverse sections of the series connection line and a multiple connection part to be described later in the branched connection part in a plane substantially perpendicular to a direction of a current flow of the series connection line and the multiple connection part.

Bus bar 3 depicted in FIG. 5 includes a plurality of series connection lines 5. Series connection lines 5 of bus bar 3 have both ends connected to each other and connecting the plurality of branched connection parts 4 to the both ends of series connection lines 5 connected to each other. Bus bar 3 depicted in FIG. 5 includes two series connection lines 5 that are disposed in parallel with each other and have the both ends coupled by branched connection parts 4 to form an entire outline in a substantially rectangular frame shape. Such a structure of coupling branched connection parts 4 with the pair of series connection lines 5 achieves increase in entire strength and reduction in electric resistance of entire series connection lines 5. The bus bar disposed on the upper surface of battery stack 10 is particularly restricted in terms of width and disposition due to other members. Provision of the plurality of series connection lines 5 facilitates design modification to a shape suitable for disposition on the upper surface of battery stack 10.

Bus bar 3 including the plurality of series connection lines 5 achieves reduction in electric resistance of entire series connection lines 5 to enable decrease in thickness and width of each of series connection lines 5. Bus bar 3 in FIG. 5 includes the pair of series connection lines 5 opposing each other and configured by main series connection line 5A having larger width and sub series connection line 5B having smaller width. Main series connection line 5A may be configured by a metal plate having 2 mm in thickness and 2 cm in lateral width to have a transverse sectional area of 40 mm², for example. Sub series connection line 5B may be configured by a metal plate having 2 mm in thickness and 4 mm in lateral width to have a transverse sectional area of 8 mm², for example.

### (Branched Connection Part 4)

Branched connection part 4 includes a plurality of terminal connection parts 6 each connected to electrode terminal 2 of battery cell 1, and multiple connection part 7 connecting terminal connection parts 6. Terminal connection parts 6 of branched connection part 4 are connected to opposing electrode terminals 2 of adjacent battery cells 1, and the plurality of battery cells 1 is connected in parallel via multiple connection part 7 connecting terminal connection parts 6. Multiple connection parts 7 in branched connection parts 4 are connected to the both ends of series connection lines 5 to couple the pair of branched connection parts 4 via series connection lines 5.

Branched connection part 4 depicted in FIG. 3 to FIG. 5 includes terminal connection parts 6 having plate shapes and projecting in the stacking direction of battery cells 1 from both sides of multiple connection part 7. Branched connection part 4 includes a pair of terminal connection parts 6A, 6B coupled to the both sides of multiple connection part 7, projecting in opposite directions, and connected to opposing electrode terminals 2 equal in polarity of battery cells 1 adjacent to each other, to connect those battery cells 1 in parallel. The pair of branched connection parts 4 coupled to the both ends of series connection lines 5 each include terminal connection part 6A projecting inward and terminal connection part 6B projecting outward. Branched connection parts 4 depicted in FIG. 5 have line symmetric shapes in a planar view.

### (Terminal Connection Part 6)

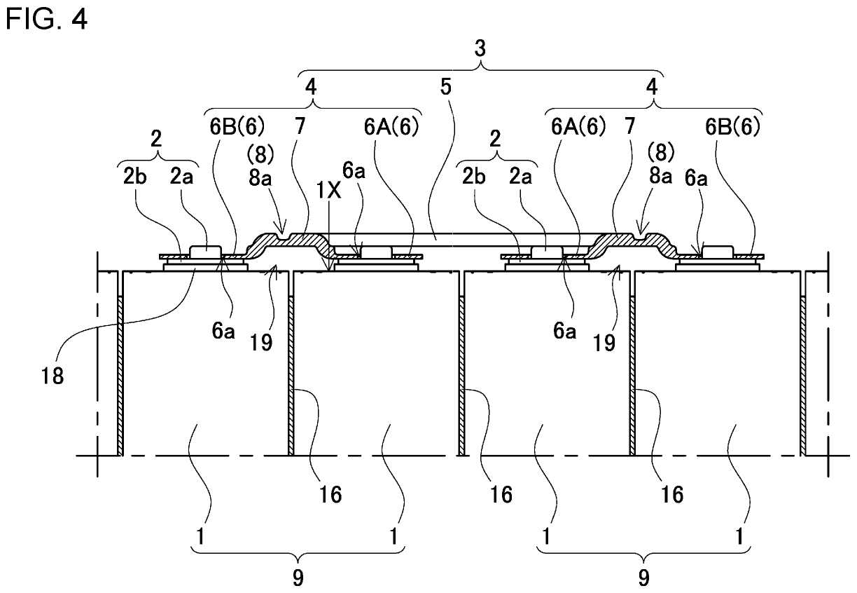

Terminal connection parts 6 depicted in FIG. 5 each have a substantially isosceles trapezoid shape gradually decreased in width along a projecting direction in a planar view. As depicted in FIG. 4, the pair of terminal connection parts 6A, 6B are disposed flush with each other to be stacked on and coupled to welding surfaces 2b of electrode terminals 2 of the plurality of battery cells 1 disposed flush with each other. Terminal connection parts 6 have flat plate shapes in parallel with terminal surfaces 1X and provided below multiple connection parts 7 as depicted in FIG. 4. Branched connection parts 4 thus configured each include multiple connection part 7 disposed above terminal connection parts 6 to provide insulating gap 19 between the upper surface of battery stack 10 and multiple connection part 7. This reliably prevents contact between multiple connection part 7 of branched connection part 4 disposed on the upper surface of battery stack 10 and the upper surfaces of battery cells 1.

Terminal connection parts 6 each have a plate shape thinner than multiple connection parts 7 and series connection lines 5 so as to be easily welded to welding surface 2b. Terminal connection part 6 in the plate shape has thickness achieving reliable laser welding of electrode terminal 2 to welding surface 2b. Terminal connection part 6 has the thickness set to be reliably welded to welding surface 2b with laser beams applied to the surface of terminal connection part 6. Terminal connection part 6 may have 0.3 mm or more, and preferably 0.4 mm or more in thickness, for example. Too large thickness needs increase in energy for laser welding of the terminal connection part to welding surface 2b. The thickness of the terminal connection part may be 2 mm or less, and preferably 1.6 mm or less, for example. Terminal connection part 6 having small thickness achieves decrease in welding energy for welding to electrode terminal 2. This achieves shorter welding time and mass production at low cost as well as suppression of adverse effect to the battery cells with smaller heat input for welding. Terminal connection part 6 may have 0.6 mm to 1.2 mm, and preferably 0.7 mm to 1.0 mm in thickness, for example.

Terminal connection part 6 further has terminal hole 6a opened to guide and position projection 2a of electrode terminal 2. Terminal hole 6a depicted in FIG. 3 to FIG. 5 is embodied by a through hole having an inner shape allowing projection 2a to be inserted. Bus bar 3 in the drawings has terminal holes 6a provided at terminal connection parts 6 and having a circular shape along an outer shape of columnar projections 2a. Terminal holes 6a opened in the plurality of terminal connection parts 6 adjacent to each other are disposed at equal intervals to have equal distances between centers. Precisely, terminal holes 6a opened in terminal connection parts 6 adjacent to each other have an interval equal to pitches of the plurality of stacked battery cells 1. Electrode terminals 2 of the plurality of battery cells 1 can thus be reliably connected via single bus bar 3. Though not depicted, each of the terminal holes may be elongated to allow a positional error of the projection of the electrode terminal to be inserted. In bus bar 3, electrode terminals 2 guided to terminal holes 6a of terminal connection parts 6 are laser-welded to connect adjacent battery cells 1 to branched connection parts 4. Laser beams are adjusted to have energy allowing terminal connection parts 6 of bus bar 3 to be reliably welded to welding surfaces 2b.

### (Multiple Connection Part 7)

Multiple connection part 7 connects the plurality of terminal connection parts 6. Multiple connection part 7 allows current flowing from terminal connection parts 6 to be joined and flow to series connection lines 5, and allows current flowing from series connection lines 5 to be divided to terminal connection parts 6. Multiple connection part 7 depicted in FIG. 4 is made thicker than terminal connection parts 6 to have smaller electric resistance and allow the sum of current flowing from terminal connection parts 6.

Multiple connection part 7 depicted in FIG. 4 and FIG. 5 is disposed between the pair of terminal connection parts 6A, 6B to physically couple the pair of terminal connection parts 6A, 6B and electrically connect the pair of terminal connection parts 6A, 6B to series connection lines 5. Multiple connection parts 7 depicted in FIG. 3 to FIG. 5 each have one end respectively coupled to the pair of series connection lines 5 to allow current flowing from terminal connection parts 6A, 6B to multiple connection part 7 to be divided to two series connection lines 5 and allow current flowing from two series connection lines 5 to be divided to the pair of terminal connection parts 6A, 6B.

The both ends of multiple connection parts 7 of the pair of branched connection parts 4 are coupled via the pair of series connection lines 5 such that bus bar 3 depicted in FIG. 5 has an entire outline in a substantially rectangular frame shape. The bus bar includes terminal connection parts 6A disposed inside center opening 3k and projecting inward from opposing multiple connection parts 7, and terminal connection parts 6B projecting outward from opposing multiple connection parts. Bus bar 3 thus configured includes the plurality of terminal connection parts 6A, 6B disposed between two opposing series connection lines 5 to easily secure a space above bus bar 3 and achieve efficient welding of terminal connection parts 6A, 6B to electrode terminals 2 of battery cells 1 from above battery stack 10.

Each of multiple connection parts 7 depicted in FIG. 4 and FIG. 5 further has groove 8a extending in a width direction of battery cells 1 and provided at a center of an upper surface. Grooves 8a extend to reach the both ends of series connection lines 5. In bus bar 3 thus configured, grooves 8a provided at multiple connection parts 7 and series connection lines 5 are deformed to serve as buffers 8 and absorb displacement in the stacking direction of the plurality of stacked battery cells 1 due to vibration, impact, or the like.

Though not depicted, the bus bar may be provided with a connection terminal for detection of voltage of the battery cells. The power source device thus configured acquires potential of electrode terminals 2 of the plurality of battery cells 1 and detects voltage of each of battery cells 1 in accordance with difference in potential thus acquired. Such a bus bar having the connection terminal can acquire potential of bus bar 3, in other words, potential of electrode terminals 2 of battery cells 1, by connecting a voltage detection line (not depicted) of a voltage detection circuit to the connection terminal.

In bus bar 3 described above, terminal connection parts 6 of branched connection parts 4 are each configured by the metal plate thinner than multiple connection parts 7 and series connection lines 5 to decrease welding energy for welding of terminal connection parts 6 to electrode terminals 2, decrease adverse effect of heat input for welding, and reduce production cost. Multiple connection parts 7 and series connection lines 5 are each configured by the metal plate thicker than terminal connection parts 6 to reduce electric resistance and allow maximum current flowing from the plurality of battery cells 1 connected in parallel.

### (Second Exemplary Embodiment)

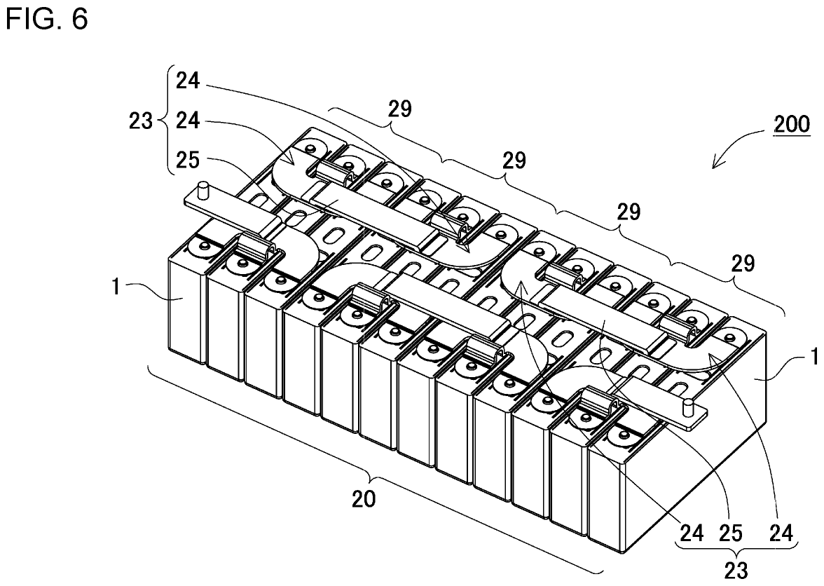

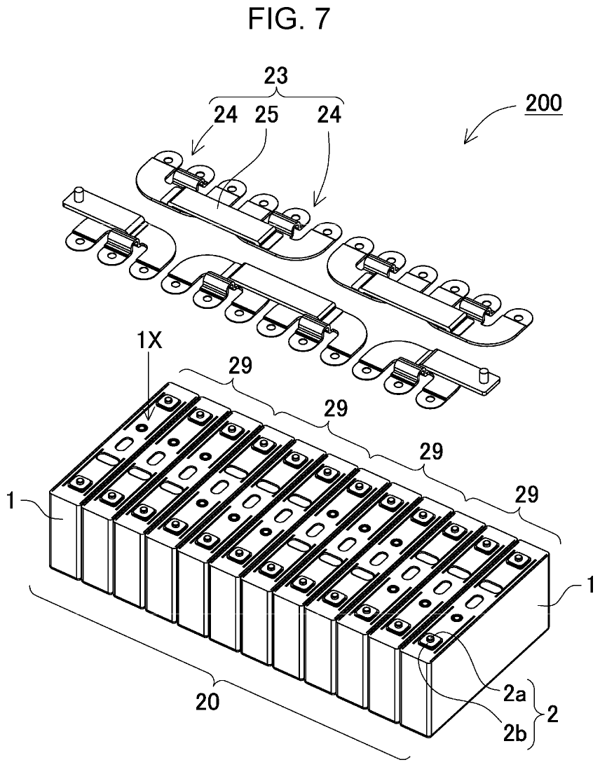

FIG. 6 to FIG. 8 depict power source device 200 according to a second exemplary embodiment. Power source device 200 includes twelve battery cells 1 stacked in the thickness direction to configure battery stack 20, in which three battery cells 1 are connected in parallel to configure parallel battery group 29 and four parallel battery groups 29 are connected in series to have twelve battery cells 1 including four sets connected in series of three battery cells connected in parallel. In battery stack 20 depicted in FIG. 7, three battery cells 1 configuring parallel battery group 29 are stacked such that positive and negative electrode terminals 2 are aligned bilaterally unidirectionally and four parallel battery groups 29 each including three battery cells 1 stacked unidirectionally are stacked such that positive and negative electrode terminals 2 are alternately inverted bilaterally. In power source device 200, opposing electrode terminals 2 of six battery cells 1 disposed adjacent to each other are connected via bus bar 23 at each side of battery stack 20 to have twelve battery cells 1 including four sets connected in series of three battery cells connected in parallel. Terminal connection part 6 has terminal holes 6a opened to guide and position projections 2a of electrode terminals 2.

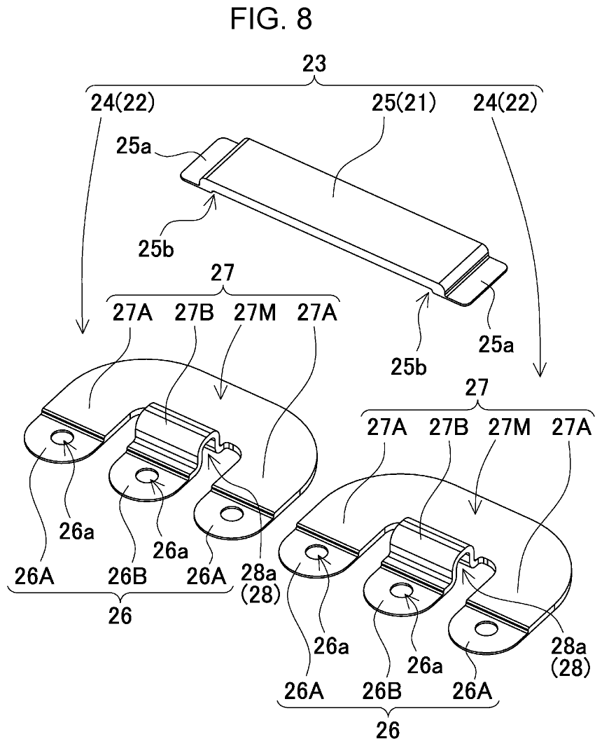

Bus bar 23 depicted in FIG. 7 and FIG. 8 includes series connection line 25 connecting in series parallel battery groups 29 each including three battery cells 1 connected in parallel, and branched connection parts 24 branched and connected to both ends of series connection line 25 and connecting in parallel three battery cells 1 configuring parallel battery group 29. Bus bar 23 depicted in FIG. 8 includes series connection line 25 configured by first metal plate 21 and branched connection parts 24 each configured by second metal plate 22. Series connection line 25 configured by first metal plate 21 in bus bar 23 has the both ends connected to branched connection parts 24 each configured by second metal plate 22 to provide branched connection parts 24 at the both ends of series connection line 25.

In order to connect in parallel three battery cells 1, branched connection parts 24 each include three terminal connection parts 26 each connected to electrode terminal 2 of battery cell 1, and multiple connection part 27 connecting those terminal connection parts 26. In bus bar 23, multiple connection parts 27 are connected to the both ends of series connection line 25 and are each branched and connected to three terminal connection parts 26. Branched connection parts 24 depicted in FIG. 8 each have a substantially E shape in a planar view to be branched into the E shape and have branched parts 27A, 27B having distal ends provided with terminal connection parts 26A, 26B. Branched connection part 24 depicted in FIG. 8 includes a pair of terminal connection parts 26A provided at branched parts 27A at both ends of multiple connection part 27, and single terminal connection part 26B provided at branched part 27B coupled to intermediate part 27M of multiple connection part 27. Branched connection part 24 has terminal holes 26a opened in three terminal connection parts 26 to be disposed at equal intervals and aligned linearly in the stacking direction of battery cells 1. Terminal connection parts 26A, 26B are thinner than branched parts 27A, 27B for easy welding of electrode terminals 2, and may have 0.6 mm to 1.2 mm and preferably 0.7 mm to 1.0 mm in thickness, for example.

Branched part 27B coupled to intermediate part 27M has curved part 28a obtained by curving an intermediate portion into a U shape to increase an energization distance from terminal connection part 26B to intermediate part 27M. This substantially equalizes distances from electrode terminals 2 connected to terminal connection parts 26A provided at branched parts 27A at the both ends of multiple connection part 27 to intermediate part 27M, and a distance from electrode terminal 2 connected to terminal connection part 26B provided at branched part 27B to intermediate part 27M. Three battery cells 1 can thus be connected in parallel while substantially equalizing electric resistance from intermediate part 27M as a connection portion between series connection line 5 and branched connection part 24 to electrode terminals 2 of three battery cells 1. Curved part 28a provided at branched part 27B serves as buffer 28 to absorb displacement in the width direction of battery cell 1 connected to terminal connection part 26B of branched part 27B.

In bus bar 23 depicted in FIG. 8, series connection line 25 configured by first metal plate 21 is disposed in a horizontal posture and the both ends of series connection line 25 are connected to multiple connection parts 27 of branched connection parts 24. Series connection line 25 has each of the ends connected to intermediate part 27M where three branched parts 27A, 27B are joined, to allow current flowing to branched parts 27A, 27B to flow into series connection line 25 without exceeding allowable current. Series connection line 25 depicted in FIG. 8 has stepped parts 25b provided at boundaries between the both ends and a main body to dispose the both ends below the main body, to have only the both ends connected to branched connection parts 24 and the main body kept contactless to branched connection parts 24. The both ends of series connection line 25 are welded to be connected to branched connection parts 24. Series connection line 25 depicted in FIG. 8 has welding parts 25a provided at the both ends to be thinner than the main body for easier welding to branched connection parts 24. Series connection line 25 is welded to branched connection parts 24 via welding parts 25a.

In bus bar 23, first metal plate 21 configuring series connection line 25 is made thicker than second metal plate 22 configuring each of branched connection parts 24. First metal plate 21 and second metal plate 22 have thickness and width most appropriately sized in consideration of maximum current to flow. For example, bus bar 23 connecting the plurality of battery cells 1 including multiple sets connected in series of three battery cells connected in parallel may have series connection line 25 configured by first metal plate 21 having 2 mm to 5 mm in thickness and 1 cm to 3 cm in lateral width to have a transverse sectional area of 50 mm² to 80 mm², and branched connection parts 24 each configured by second metal plate 22 having, particularly at branched parts 27A, 27B of multiple connection part 27, 1 mm to 3 mm in thickness and 1 cm to 3 cm in lateral width to have a transverse sectional area of 30 mm² to 60 mm². In bus bar 23, series connection line 25 may have 3 mm in thickness and 2 cm in lateral width to have a transverse sectional area of 60 mm², and branched parts 27A, 27B of branched connection parts 24 may have 2 mm in thickness and 2 cm in lateral width to have a transverse sectional area of 40 mm².

In bus bar 23 described above, terminal connection parts 26 of branched connection parts 24 are each configured by the metal plate thinner than multiple connection parts 27 and series connection line 25 to decrease welding energy for welding of terminal connection parts 26 to electrode terminals 2, decrease adverse effect of heat input for welding, and reduce production cost. Series connection line 25 having a flow of current obtained by joining current of three battery cells 1 connected in parallel is configured by the metal plate thicker than branched connection parts 24 to reduce electric resistance of series connection line 25 and reliably allow maximum current flowing from three battery cells 1.

### (Third Exemplary Embodiment)

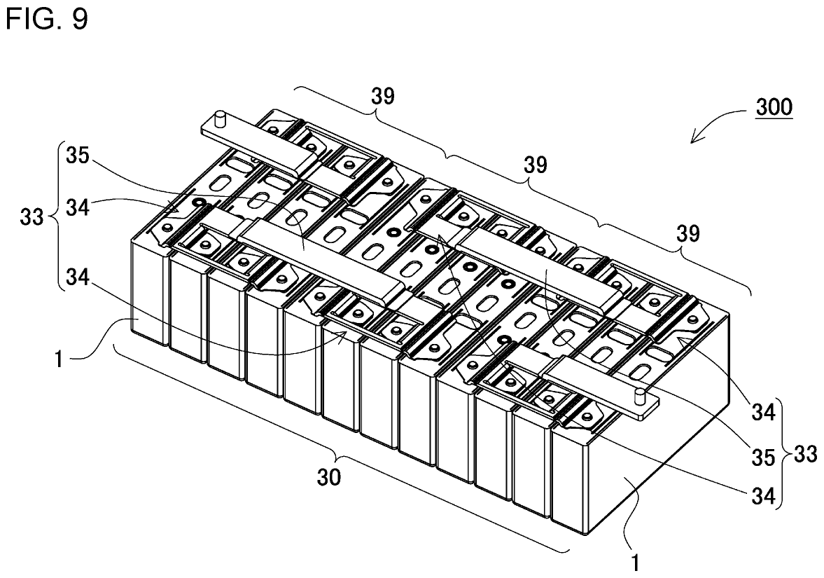

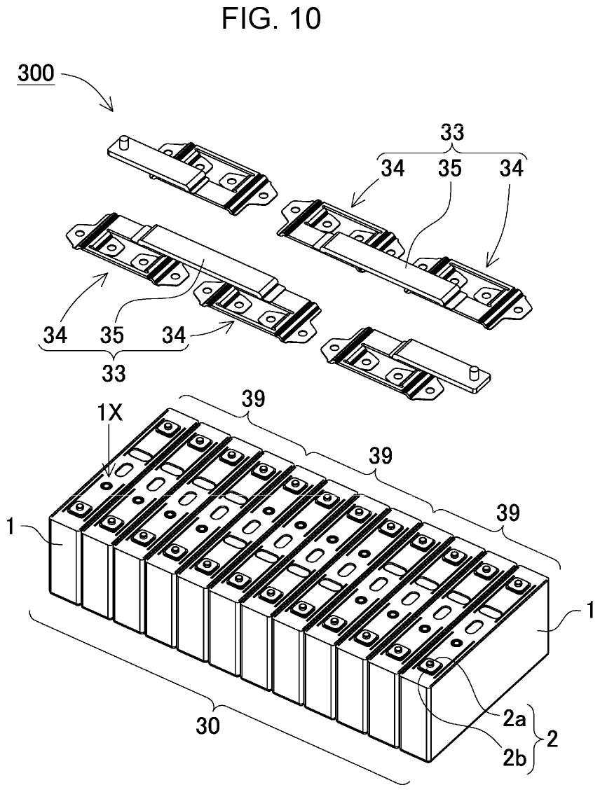

FIG. 9 to FIG. 11 depict power source device 300 according to a third exemplary embodiment. Power source device 300 includes twelve battery cells 1 stacked in the thickness direction to configure battery stack 30, in which four battery cells 1 are connected in parallel to configure parallel battery group 39 and three parallel battery groups 39 are connected in series to have twelve battery cells 1 including three sets connected in series of four battery cells connected in parallel. In battery stack 30 depicted in FIG. 10, four battery cells 1 configuring parallel battery group 39 are stacked such that positive and negative electrode terminals 2 are aligned bilaterally unidirectionally and three parallel battery groups 39 each including four battery cells 1 stacked unidirectionally are stacked such that positive and negative electrode terminals 2 are alternately inverted bilaterally. In power source device 300, opposing electrode terminals 2 of eight battery cells 1 disposed adjacent to each other are connected via bus bars 33 at each side of battery stack 30 to have twelve battery cells 1 including three sets connected in series of four battery cells connected in parallel.

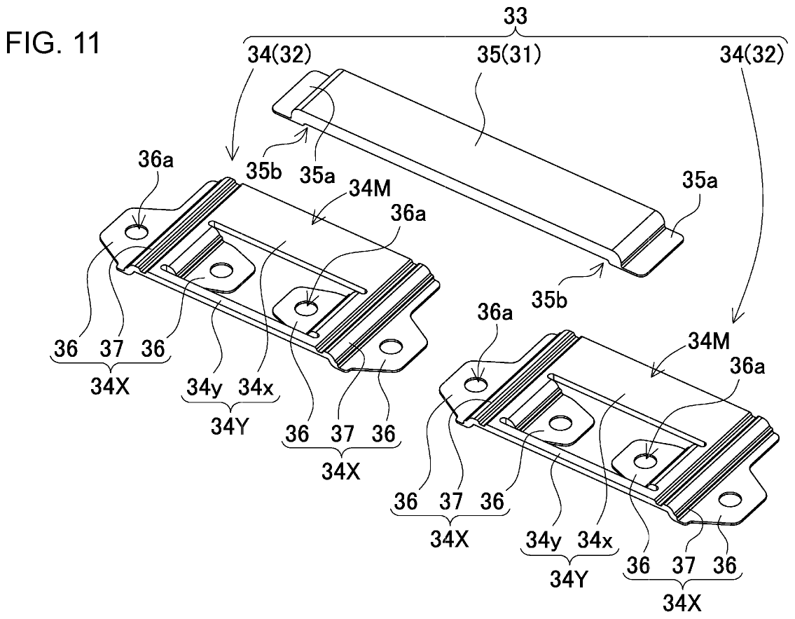

Bus bar 33 depicted in FIG. 10 and FIG. 11 includes series connection line 35 connecting in series parallel battery groups 39 each including four battery cells 1 connected in parallel, and branched connection parts 34 branched and connected to both ends of series connection line 35 and connecting in parallel four battery cells 1 configuring parallel battery group 39. Bus bar 33 depicted in FIG. 11 also includes series connection line 35 configured by first metal plate 31 and branched connection parts 34 each configured by second metal plate 32, and series connection line 35 configured by first metal plate 31 has the both ends connected to branched connection parts 34 each configured by second metal plate 32.

Each of branched connection parts 34 includes two first branched connection parts 34X each connecting two battery cells in parallel, and second branched connection part 34Y having both ends connected to first branched connection parts 34X. First branched connection parts 34X each include two terminal connection parts 36 connected to electrode terminals 2 of two battery cells 1 adjacent to each other, and multiple connection part 37 connecting terminal connection parts 36, to connect in parallel battery cells 1 connected to terminal connection parts 36 via multiple connection part 37. Each of terminal connection parts 36 has terminal hole 36a opened to guide projection 2a of electrode terminal 2. Second branched connection part 34Y includes two parallel connection lines 34x, 34y having both ends coupled by first branched connection parts 34X to form an entire outline in a substantially rectangular frame shape. Branched connection part 34 connects in parallel, via second branched connection part 34Y, two sets of two battery cells 1 connected in parallel via first branched connection parts 34X to configure parallel battery group 39 including four battery cells 1 connected in parallel.

Branched connection part 34 thus configured may be embodied by bus bar 3 according to the first exemplary embodiment depicted in FIG. 3 to FIG. 5. In this case, branched connection parts 4 and series connection lines 5 in bus bar 3 depicted in FIG. 5 correspond to first branched connection parts 34X and second branched connection part 34Y in bus bar 33 depicted in FIG. 11, respectively. Branched connection part 34 can thus be formed by pressing a single metal plate as described above to enable simple and easy mass production.

In bus bar 33 depicted in FIG. 11, series connection line 35 configured by first metal plate 31 is disposed in a horizontal posture and the both ends of series connection line 35 are connected to second branched connection parts 34Y of branched connection parts 34. Each of the ends of series connection line 35 is connected to intermediate part 34M of one of two second branched connection parts 34Y, namely, wider parallel connection line 34x. In bus bar 33, series connection line 35 connects in series two branched connection parts 34 each connecting in parallel, via second branched connection part 34Y, first branched connection parts 34X each connecting two battery cells 1. Series connection line 35 thus has a flow of the sum of current flowing to four battery cells 1. First metal plate 31 configuring series connection line 35 is accordingly made thicker than second metal plate 32 configuring branched connection part 34 to allow maximum current flowing to series connection line 35. The both ends of series connection line 35 in bus bar 33 are connected to intermediate parts 34M of parallel connection lines 34x. Current flowing from series connection line 35 to each of parallel connection lines 34x is branched at intermediate part 34M toward the both ends of parallel connection line 34x, and current flowing from the both ends of parallel connection line 34x to series connection line 35 joins at intermediate part 34M of parallel connection line 34x to flow into series connection line 35. Each of the ends of parallel connection line 34x in second branched connection part 34Y thus has a flow of current flowing to two battery cells 1. Branched connection part 34 can allow current flowing to parallel connection line 34x without being thickened to be equivalent to series connection line 35.

Series connection line 35 depicted in FIG. 11 has stepped parts 35b provided at boundaries between the both ends and a main body to dispose the both ends below the main body, to have only the both ends connected to intermediate parts 34M of branched connection parts 34 and the main body kept contactless to branched connection parts 34. The both ends of series connection line 35 are also welded to be connected to branched connection parts 34. Series connection line 35 depicted in FIG. 11 has welding parts 35a provided at the both ends to be thinner than the main body for easier welding to branched connection parts 34. Series connection line 35 is welded to branched connection parts 34 via welding parts 35a.

In bus bar 33, first metal plate 31 configuring series connection line 35 is made thicker than second metal plate 32 configuring branched connection part 34. First metal plate 31 and second metal plate 32 have thickness and width most appropriately sized in consideration of maximum current to flow. For example, bus bar 33 connecting the plurality of battery cells 1 including multiple sets connected in series of four battery cells connected in parallel may have series connection line 35 configured by first metal plate 31 having 3 mm to 8 mm in thickness and 1 cm to 3 cm in lateral width to have a transverse sectional area of 60 mm² to 100 mm², and branched connection parts 34 each configured by second metal plate 32 having, particularly at parallel connection line 34M, 1 mm to 3 mm in thickness and 1 cm to 3 cm in lateral width to have a transverse sectional area of 30 mm² to 60 mm². In bus bar 33, series connection line 35 may have 4 mm in thickness and 2 cm in lateral width to have a transverse sectional area of 80 mm², and parallel connection lines 34x of branched connection parts 34 may have 2 mm in thickness and 2 cm in lateral width to have a transverse sectional area of 40 mm², for example.

### (Fourth Exemplary Embodiment)

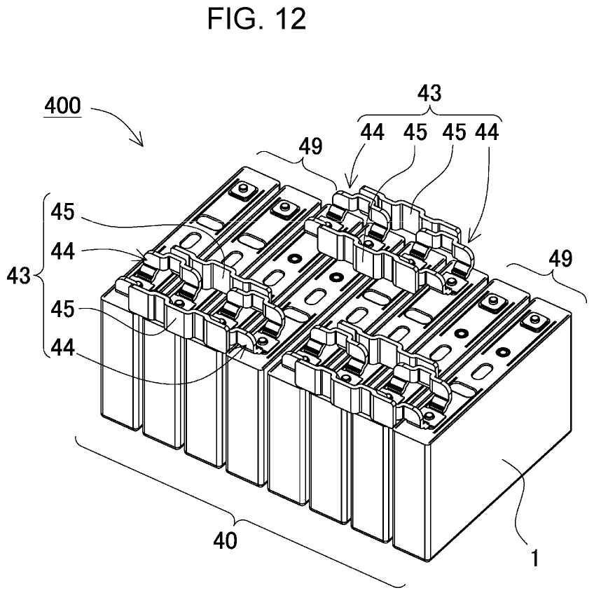

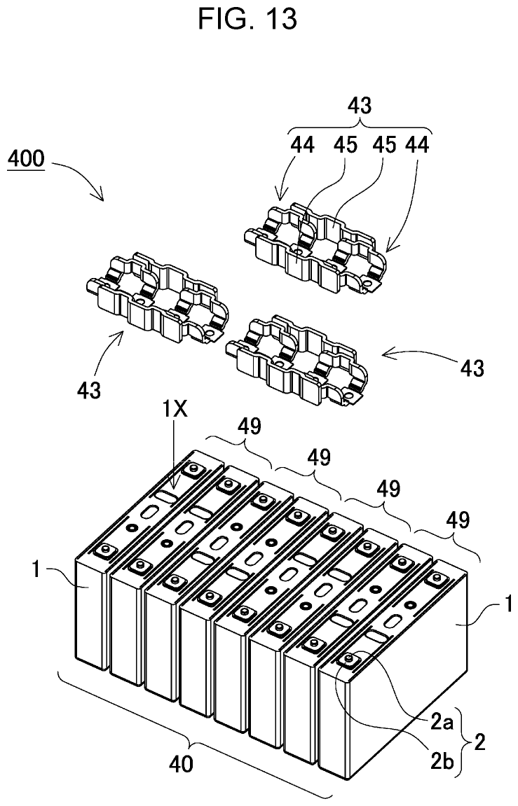

FIG. 12 to FIG. 14 depict power source device 400 according to a fourth exemplary embodiment. Power source device 400 includes eight battery cells 1 stacked in the thickness direction to configure battery stack 40, in which two battery cells 1 are connected in parallel to configure parallel battery group 49 and four parallel battery groups 49 are connected in series to have eight battery cells 1 including four sets connected in series of two battery cells connected in parallel. In battery stack 40 depicted in FIG. 13, two battery cells 1 configuring parallel battery group 49 are stacked such that positive and negative electrode terminals 2 are aligned bilaterally unidirectionally and four parallel battery groups 49 each including two battery cells 1 stacked unidirectionally are stacked such that positive and negative electrode terminals 2 are alternately inverted bilaterally. In power source device 400, opposing electrode terminals 2 of four battery cells 1 disposed adjacent to each other are connected via bus bars 43 at each side of battery stack 40 to have eight battery cells 1 including four sets connected in series of two battery cells connected in parallel.

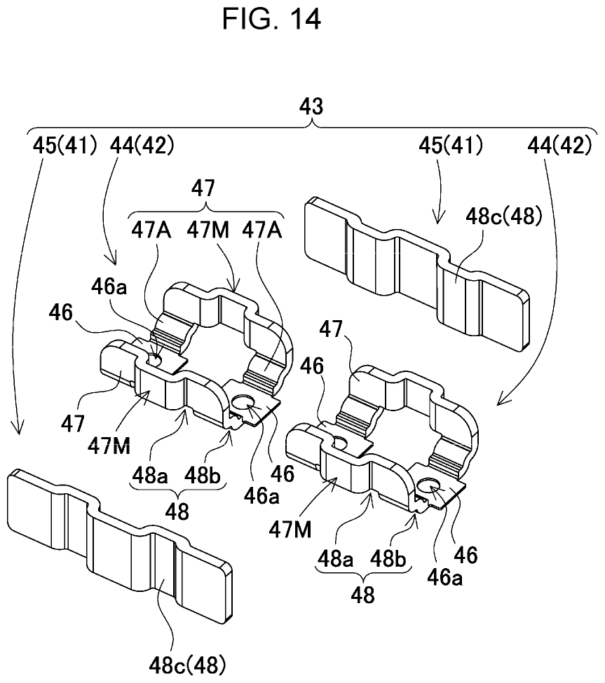

Bus bar 43 depicted in FIG. 13 and FIG. 14 includes series connection lines 45 connecting in series parallel battery groups 49 each including two battery cells 1 connected in parallel, and branched connection parts 44 branched and connected to both ends of series connection lines 45 and connecting in parallel two battery cells 1 configuring parallel battery group 49. Bus bar 43 depicted in FIG. 14 includes series connection lines 45 each configured by first metal plate 41 and branched connection parts 44 each configured by second metal plate 42. Two series connection lines 45 configured by two first metal plates 41 in bus bar 43 have both ends connected to a pair of branched connection parts 44 configured by second metal plates 42 to provide branched connection parts 44 at the both ends of series connection lines 45.

In order to connect in parallel two battery cells 1, branched connection parts 44 each include two terminal connection parts 46 connected to electrode terminals 2 of two adjacent battery cells 1, and a pair of multiple connection parts 47 coupling both sides of terminal connection parts 46. Branched connection part 44 connects in parallel battery cells 1 connected to terminal connection parts 46 via two multiple connection parts 47 opposing each other. In bus bar 43, multiple connection parts 47 are connected to the both ends of two series connection lines 45 opposing each other and are each branched and connected to two terminal connection parts 46. Each of multiple connection parts 47 has a substantially cornered U shape in a planar view to be branched into the cornered U shape and have branched parts 47A having distal ends provided with terminal connection parts 46. Each of terminal connection parts 46 has terminal hole 46a opened to guide projection 2a of electrode terminal 2. Branched connection part 44 includes the pair of multiple connection parts 47 that are connected to the both sides of the pair of terminal connection parts 46 and are bent vertically at branched parts 47A to be disposed above terminal connection parts 46 in vertical postures opposing each other. Multiple connection parts 47 having the vertical postures with respect to terminal surfaces 1X each have bent parts 48a bent to have a stepped crank shape at both sides of intermediate part 47M connected to the both ends of series connection line 45, and branched parts 47A disposed outside bent parts 48a and extended downward are horizontally bent to be connected to terminal connection parts 46. Branched connection part 44 thus configured includes bent parts 48a provided at the both sides of intermediate parts 47M of multiple connection parts 47 and bent parts 48b provided at branched parts 47A extended downward. Bent parts 48a and bent parts 48b are deformed to serve as buffers 48 and absorb displacement in the stacking direction and the width direction of the plurality of stacked battery cells 1.

In bus bar 43 depicted in FIG. 14, two series connection lines 45 configured by first metal plates 41 are disposed in the vertical postures and the both ends of series connection lines 45 are connected to multiple connection parts 47 of branched connection parts 44. Series connection lines 45 have the both ends connected to intermediate parts 47M of multiple connection parts 47, to allow current flowing to branched parts 47A to flow into series connection lines 45 without exceeding allowable current. Furthermore, series connection lines 45 depicted in FIG. 14 are each bent to have a crank shape with a plurality of recesses and protrusions aligned in a length direction, to have bent parts 48c deformed to serve as buffers 48 and absorb displacement in the stacking direction and the width direction of the plurality of stacked battery cells 1.

In bus bar 43, first metal plates 41 configuring series connection lines 45 are wider to be larger in transverse sectional area than second metal plates 42 configuring branched connection parts 44. First metal plates 41 and second metal plates 42 have thickness and width most appropriately sized in consideration of maximum current to flow. For example, bus bar 43 connecting the plurality of battery cells 1 including multiple sets connected in series of two battery cells connected in parallel may have series connection lines 45 configured by first metal plates 41 having 2 mm to 4 mm in thickness and 1 cm to 3 cm in lateral width to have a transverse sectional area of 50 mm² to 70 mm², and branched connection parts 44 configured by second metal plates 42 having, particularly at multiple connection parts 47, 2 mm to 4 mm in thickness and 0.5 cm to 2 cm in lateral width to have a transverse sectional area of 20 mm² to 50 mm². In bus bar 43, for example, series connection lines 45 may have 3 mm in thickness and 2 cm in lateral width to have a transverse sectional area of 60 mm², and multiple connection parts 47 of branched connection parts 44 may have 3 mm in thickness and 1 cm in lateral width to have a transverse sectional area of 30 mm².

Bus bar 43 described above includes the pair of series connection lines 45 connected to the both sides of the pair of branched connection parts 44 to achieve well-balanced coupling between the pair of branched connection parts 44 via the two series connection lines 45 and disposition of series connection lines 45 having low resistance for ideal energization. The bus bar includes multiple connection parts 47 of branched connection parts 44 and series connection lines 45 each having a plate shape and disposed in a vertical posture with respect to terminal surfaces 1X of battery cells 1, to allow external air to come in efficient contact with surfaces of multiple connection parts 47 and series connection lines 45. The branched connection parts and the series connection lines in bus bar 43 also serve as radiator fins to effectively radiate heat of the battery cells.

### (Fifth Exemplary Embodiment)

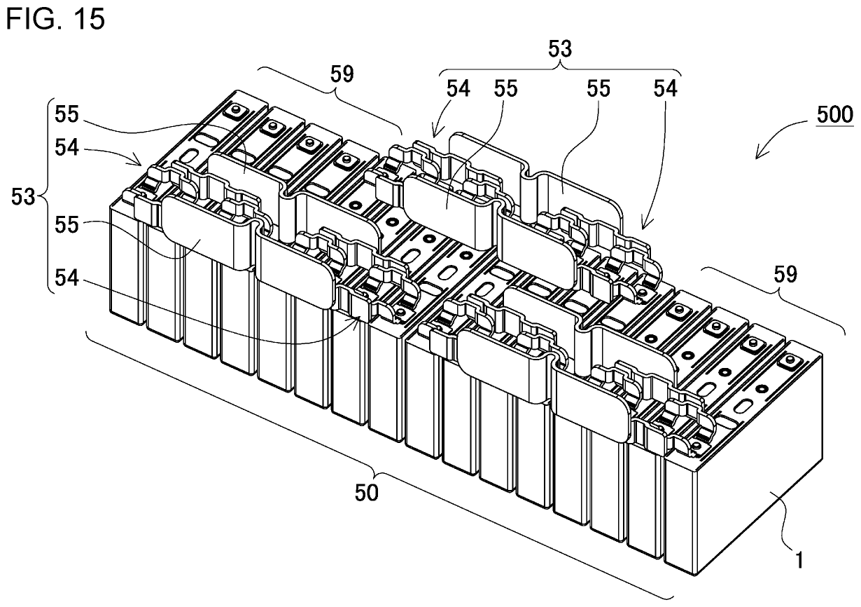

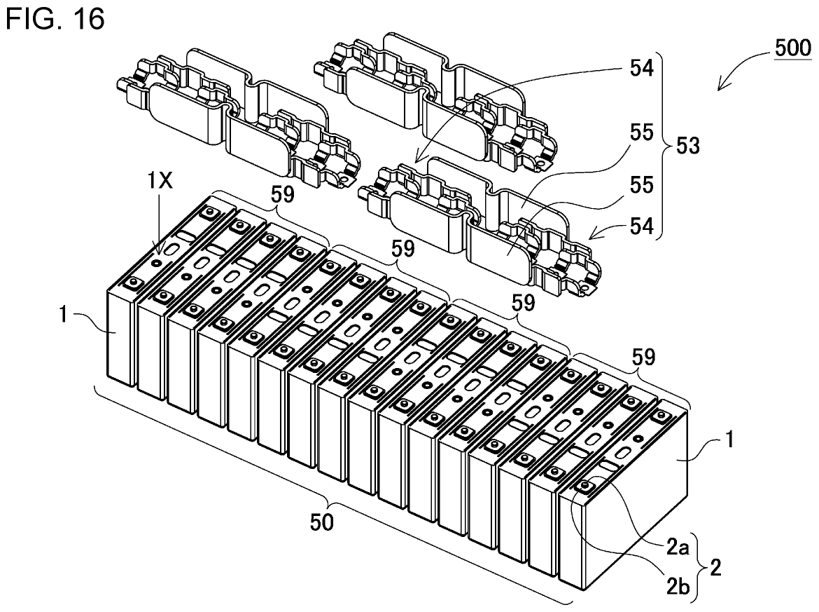

FIG. 15 to FIG. 17 depict power source device 500 according to a fifth exemplary embodiment. Power source device 500 includes sixteen battery cells 1 stacked in the thickness direction to configure battery stack 50, in which four battery cells 1 are connected in parallel to configure parallel battery group 59 and four parallel battery groups 59 are connected in series to have sixteen battery cells 1 including four sets connected in series of four battery cells connected in parallel. In battery stack 50 depicted in FIG. 16, four battery cells 1 configuring parallel battery group 59 are stacked such that positive and negative electrode terminals 2 are aligned bilaterally unidirectionally and four parallel battery groups 59 each including four battery cells 1 stacked unidirectionally are stacked such that positive and negative electrode terminals 2 are alternately inverted bilaterally. In power source device 500, opposing electrode terminals 2 of eight battery cells 1 disposed adjacent to each other are connected via bus bars 53 at each side of battery stack 50 to have sixteen battery cells 1 including four sets connected in series of four battery cells connected in parallel.

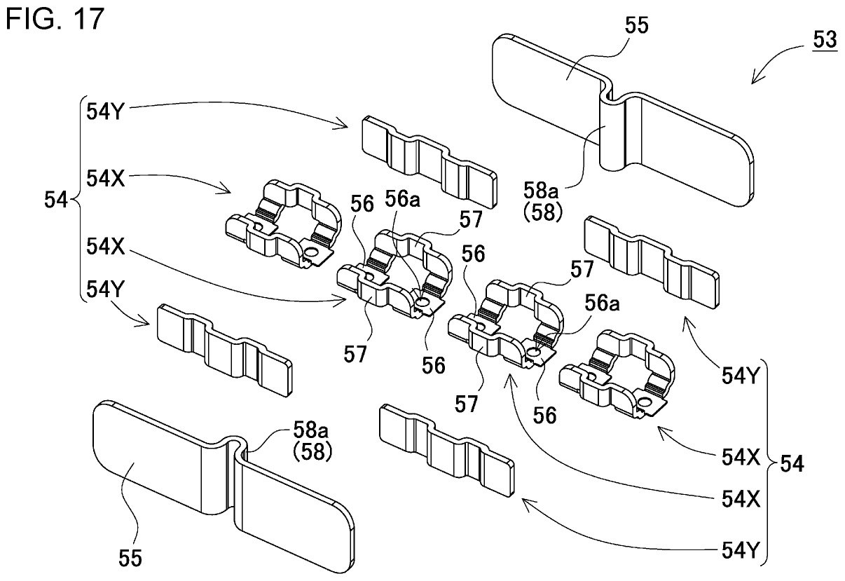

Bus bar 53 depicted in FIG. 16 and FIG. 17 includes two series connection lines 55 connecting in series parallel battery groups 59 each including four battery cells 1 connected in parallel, and branched connection parts 54 branched and connected to both ends of series connection lines 55 and connecting in parallel four battery cells 1 configuring parallel battery group 59.

In order to connect four battery cells 1 in parallel, each of branched connection parts 54 includes two first branched connection parts 54X each connecting two battery cells 1 in parallel, and two second branched connection parts 54Y having both ends connected to first branched connection parts 54X. First branched connection parts 54X each include two terminal connection parts 56 connected to electrode terminals 2 of two battery cells 1 adjacent to each other, and a pair of multiple connection parts 57 coupling both sides of terminal connection parts 56, to connect in parallel battery cells 1 connected to terminal connection parts 56 via two multiple connection parts 57 opposing each other. Each of terminal connection parts 56 has terminal hole 56a opened to guide projection 2a of electrode terminal 2. Two second branched connection parts 54Y are disposed at the both sides of the pair of first branched connection parts 54X and have both ends connected to first branched connection parts 34X. Each of branched connection parts 54 connects in parallel, via second branched connection parts 54Y, two sets of two battery cells 1 connected in parallel via first branched connection parts 54X to configure parallel battery group 59 including four battery cells 1 connected in parallel.

Branched connection part 54 thus configured may be embodied by bus bar 43 according to the fourth exemplary embodiment depicted in FIG. 13 and FIG. 14. In this case, branched connection parts 44 and series connection lines 45 in bus bar 43 depicted in FIG. 14 correspond to first branched connection parts 54X and second branched connection parts 54Y in bus bar 53 depicted in FIG. 17, respectively. Branched connection part 54 is thus formed by connecting two types of pressed metal plates as described above.

In bus bar 53 depicted in FIG. 17, two series connection lines 55 configured by two metal plates are disposed at the both sides of branched connection parts 54 in vertical postures opposing each other, and the both ends of series connection lines 55 are connected to branched connection parts 54. Series connection lines 55 have the both ends connected to intermediate parts of second branched connection parts 54Y. In bus bar 53, series connection lines 55 connect in series two branched connection parts 54 each connecting in parallel, via second branched connection parts 54Y, first branched connection parts 54X each connecting two battery cells 1. Series connection lines 55 thus have a flow of the sum of current flowing to four battery cells 1. Series connection lines 55 are accordingly configured by metal plates having larger width and a larger transverse sectional area than second branched connection parts 54Y, to allow maximum current flowing to series connection lines 55. The both ends of series connection lines 55 in bus bar 53 are connected to intermediate parts 54M of second branched connection parts 54Y. Current flowing from each of series connection lines 55 to each of second branched connection parts 54Y is branched at intermediate part 54M toward the both ends, and current flowing from the both ends of second branched connection part 54Y to series connection line 55 joins at intermediate part 54M of second branched connection part 54Y to flow into series connection line 55.

Each of the ends of second branched connection part 54Y thus has a flow of current flowing to two battery cells 1. Each of branched connection parts 54 thus allows current flowing to second branched connection parts 54Y without increase in transverse sectional area of second branched connection parts 54Y to be equivalent to series connection lines 55.

Furthermore, series connection lines 55 depicted in FIG. 17 each have an intermediate portion in the length direction curved to have a U shape, to have curved part 58a deformed to serve as buffer 58 and absorb displacement in the stacking direction and the width direction of the plurality of stacked battery cells 1. Bus bar 53 also includes branched connection parts 54 and series connection lines 55 each having a plate shape and disposed in a vertical posture with respect to terminal surfaces 1X of battery cells 1, so that branched connection parts 54 and series connection lines 55 also serve as radiator fins to effectively radiate heat of the battery cells. In particular, series connection lines 55 are increased in width for increase in transverse sectional area, to achieve reduction in electric resistance and effective heat radiation with a larger surface area.

In bus bar 53 described above, second branched connection parts 54Y are configured by metal plates thicker than terminal connection parts 56, series connection lines 55 are configured by metal plates larger in transverse sectional area than second branched connection parts 54Y, and second branched connection parts 54Y are configured by metal plates larger in transverse sectional area than multiple connection parts 57 of first branched connection parts 54X. Series connection lines 55, second branched connection parts 54Y, and multiple connection parts 57 of the first branched connection parts have thickness and width most appropriately sized in consideration of maximum current to flow. For example, bus bar 53 connecting the plurality of battery cells 1 including multiple sets connected in series of four battery cells connected in parallel may have series connection lines 55 configured by metal plates having 2 mm to 5 mm in thickness and 2 cm to 5 cm in lateral width to have a transverse sectional area of 80 mm² to 150 mm², second branched connection parts 54X configured by metal plates having 2 mm to 4 mm in thickness and 1 cm to 3 cm in lateral width to have a transverse sectional area of 40 mm² to 80 mm², and multiple connection parts 57 of first branched connection parts 54X configured by metal plates having 1 mm to 3 mm in thickness and 0.5 cm to 2 cm in lateral width to have a transverse sectional area of 20 mm² to 40 mm². In bus bar 53, for example, series connection lines 55 may have 3 mm in thickness and 4 cm in lateral width to have a transverse sectional area of 120 mm², second branched connection parts 54Y may have 3 mm in thickness and 2 cm in lateral width to have a transverse sectional area of 60 mm², and multiple connection parts 57 of first branched connection parts 54X may have 3 mm in thickness and 1 cm in lateral width to have a transverse sectional area of 30 mm².

(Sixth Exemplary embodiment)

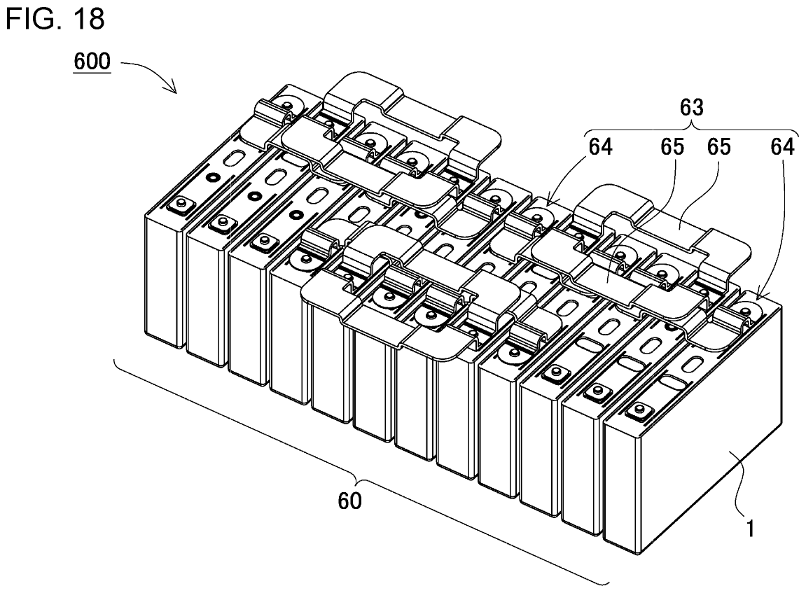

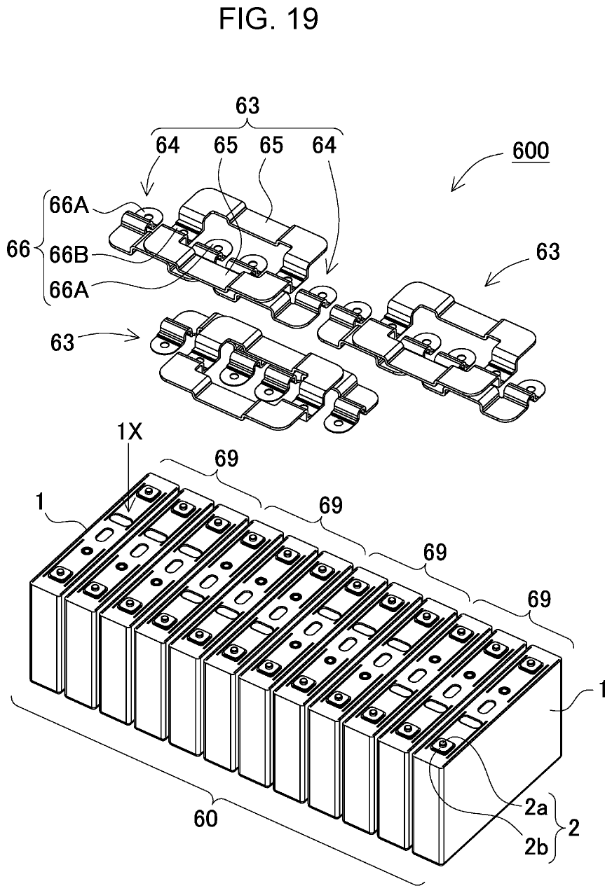

FIG. 18 to FIG. 20 depict power source device 600 according to a sixth exemplary embodiment. Power source device 600 includes twelve battery cells 1 stacked in the thickness direction to configure battery stack 60, in which three battery cells 1 are connected in parallel to configure parallel battery group 69 and four parallel battery groups 69 are connected in series to have twelve battery cells 1 including four sets connected in series of three battery cells connected in parallel. In battery stack 60 depicted in FIG. 19, three battery cells 1 configuring parallel battery group 69 are stacked such that positive and negative electrode terminals 2 are aligned bilaterally unidirectionally and four parallel battery groups 69 each including three battery cells 1 stacked unidirectionally are stacked such that positive and negative electrode terminals 2 are alternately inverted bilaterally. In power source device 600, opposing electrode terminals 2 of six battery cells 1 disposed adjacent to each other are connected via bus bar 63 at each side of battery stack 60 to have twelve battery cells 1 including four sets connected in series of three battery cells connected in parallel.

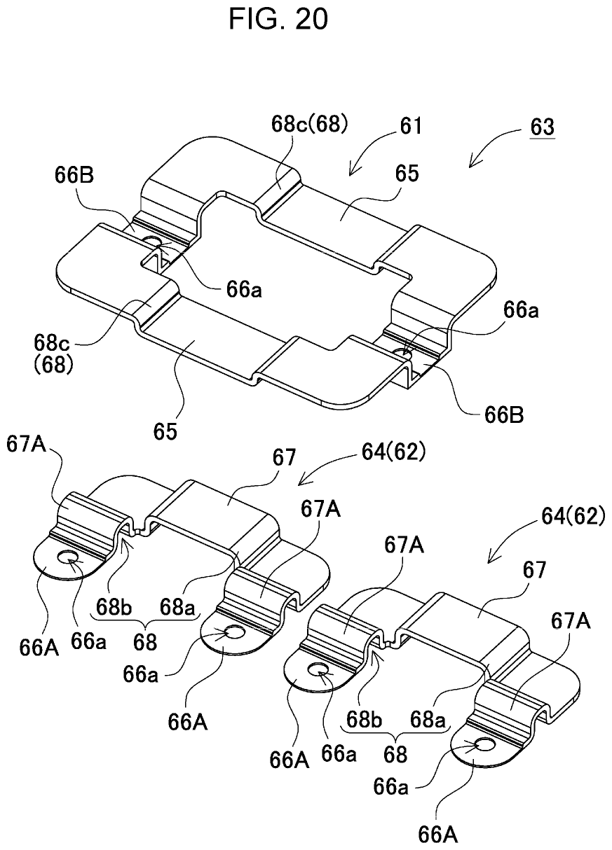

Bus bar 63 depicted in FIG. 20 includes series connection lines 65 configured by first metal plate 61 and branched connection parts 64 each configured by second metal plate 62. In bus bar 63, first metal plate 61 includes a plurality of series connection lines 65 having both ends connected. Each end of first metal plate 61 is connected to second metal plate 62 to dispose branched connection part 64 at each of the ends of series connection lines 65. In bus bar 63 depicted in FIG. 19 and FIG. 20, parallel battery groups 69 each including three battery cells 1 connected in parallel are connected in series via series connection lines 65, and branched connection parts 64 disposed at the both ends of series connection lines 65 are each configured to connect two battery cells 1 in parallel. Branched connection part 64 includes multiple connection part 67 having a substantially cornered U shape in a planar view and branched to two branched parts 67A having distal ends provided with two terminal connection parts 66A. In order to connect in parallel three battery cells 1 configuring parallel battery group 69, bus bar 63 includes terminal connection parts 66B connecting electrode terminals 2 of battery cells 1 to coupling parts of two series connection lines 65 having the both ends coupled.

In bus bar 63, first metal plate 61 coupling two series connection lines 65 has the both ends connected to second metal plates 62 configuring branched connection parts 64. In a state where second metal plates 62 are connected to the both ends of first metal plate 61 in bus bar 63, terminal connection part 66B provided at each of the ends of first metal plate 61 is positioned between two terminal connection parts 66A provided at branched connection part 64 to linearly dispose terminal connection parts 66A and terminal connection part 66B. Bus bar 63 includes six terminal connection parts 66A, 66B disposed linearly and having terminal holes 66a provided at equal intervals. In bus bar 63, two battery cells 1 connected to terminal connection parts 66A of branched connection part 64 configured by second metal plate 62 and single battery cell 1 connected to terminal connection part 66B of second metal plate 61 are connected in parallel to configure parallel battery group 69. Two parallel battery groups 69 are connected via two series connection lines 65 to achieve sets connected in series of three battery cells 1.

Two series connection lines 65 configured by first metal plate 61 are coupled to each other to have a rectangular frame shape in a planar view, and terminal connection parts 66B provided at the coupling parts are disposed below remaining parts and made thinner than series connection lines 65. Series connection lines 65 coupled to have the frame shape each have an intermediate part provided with a plurality of bent parts 68c to be stepped, and those bent parts 68c serve as buffers 68 to absorb displacement of the plurality of battery cells 1 connected via bus bar 63. In branched connection part 64 configured by second metal plate 62, multiple connection part 67 has an intermediate part provided with a plurality of bent parts 68a, and two branched parts 67A are provided with curved parts 68b. Bent parts 68a and curved parts 68b serve as buffers to absorb displacement in the stacking direction and the width direction of the plurality of battery cells 1 coupled via bus bar 63.

In bus bar 63, series connection lines 65 and multiple connection parts 67 of branched connection parts 64 may be configured by metal plates substantially equal in thickness and width. It is because two parallel battery groups 69 are connected in series via two series connection lines 65. Bus bar 63 for series connection via two series connection lines 65 has current flows branched to series connection lines 65 to safely allow maximum current flowing to series connection lines 65. Bus bar 63 connecting the plurality of battery cells 1 including multiple sets connected in series of three battery cells connected in parallel may have series connection lines 65 and branched connection parts 64 having 1 mm to 3 mm in thickness and 1 cm to 3 cm in lateral width to have a transverse sectional area of 20 mm² to 60 mm², for example. Series connection lines 65 and branched connection parts 64 in bus bar 53 may have 2 mm in thickness and 2 cm in lateral width to have a transverse sectional area of 40 mm², for example.

As described in each of the second to fourth and sixth exemplary embodiments, the bus bar configured by the plurality of metal plates (such as the first metal plate and the second metal plate) may preliminarily be welded at fixed positions to be integrated, and the bus bar may be then disposed on the upper surface of the battery stack to be welded to the electrode terminals of the plurality of battery cells. In this case, welding to the battery stack needs welding only between the terminal connection parts of the branched connection parts and the electrode terminals, to achieve decrease in welding time and decrease in adverse effect due to heat input. The plurality of metal plates configuring the bus bar may not preliminarily be welded to be fixed, but may alternatively be welded upon connection to the battery stack. In this case, the second metal plates each configuring the branched connection part is first connected to the electrode terminals of the battery cells and then the branched connection parts adjacent to each other are welded and connected via the series connection line configured by the first metal plate to connect in series the parallel battery groups. The branched connection part is welded to the battery cells configuring each parallel battery group and then the branched connection parts connected to the electrode terminals of the battery cells are connected via the series connection line in this case, to achieve decreased connection displacement between the bus bar and the electrode terminals due to positional errors of the electrode terminals between the parallel battery groups. This achieves stable connection states between the electrode terminals and the bus bar.

The power source device described above is applicable as a power source mounted on a vehicle. Examples of such a vehicle equipped with a power source device include electrically driven vehicles such as a hybrid vehicle or a plug-in hybrid vehicle configured to travel with use of both an engine and a motor, and an electric vehicle configured to travel with use of only a motor. The power source device is applied as a power source of such a vehicle. Exemplarily described below is power source device 1000 achieving large capacitance and high output power by connecting a large number of the power source devices in series and in parallel and additionally providing necessary control circuits, to obtain electric power used to drive the vehicle.

### (Power Source Device For Hybrid Vehicle)

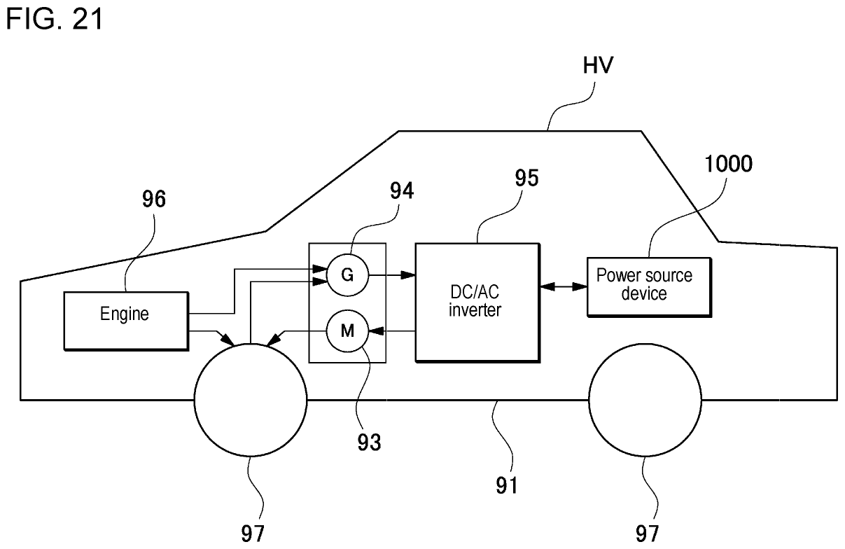

FIG. 21 exemplarily depicts a hybrid vehicle configured to travel with use of both an engine and a motor and equipped with a power source device. This diagram depicts vehicle HV equipped with the power source device and including vehicle body 91, engine 96 and traction motor 93 used to travel vehicle body 91, wheels 97 driven by engine 96 and traction motor 93, power source device 1000 configured to supply motor 93 with electric power, and power generator 94 configured to charge batteries included in power source device 1000. Power source device 1000 is connected to motor 93 and power generator 94 via DC/AC inverter 95. Vehicle HV is configured to travel with use of both motor 93 and engine 96 while charging and discharging the batteries in power source device 1000. Motor 93 is driven to travel the vehicle during acceleration and during travel at low speed having poor engine efficiency. Motor 93 is driven when electric power is supplied from power source device 1000. Power generator 94 is driven by engine 96 or driven through regenerative braking upon braking the vehicle to charge the batteries in power source device 1000.

### (Power Source Device For Electric Vehicle)

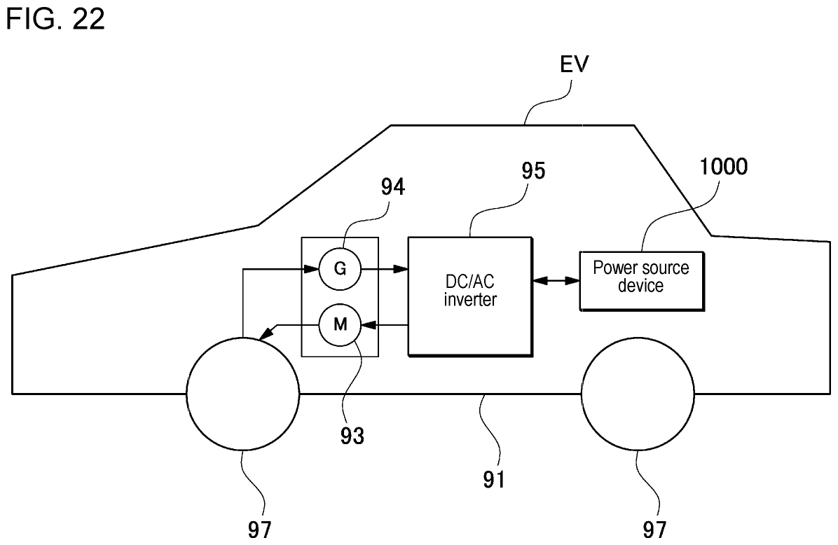

FIG. 22 exemplarily depicts an electric vehicle configured to travel with use of only a motor and equipped with the power source device. This diagram depicts vehicle EV equipped with the power source device and including vehicle body 91, traction motor 93 used to travel vehicle body 91, wheels 97 driven by motor 93, power source device 1000 configured to supply motor 93 with electric power, and power generator 94 configured to charge the batteries included in power source device 1000. Power source device 100 is connected to motor 93 and power generator 94 via DC/AC inverter 95. Motor 93 is driven when electric power is supplied from power source device 1000. Power generator 94 is driven by energy upon regenerative braking of vehicle EV to charge the batteries in power source device 1000.

### (Power Storage System)

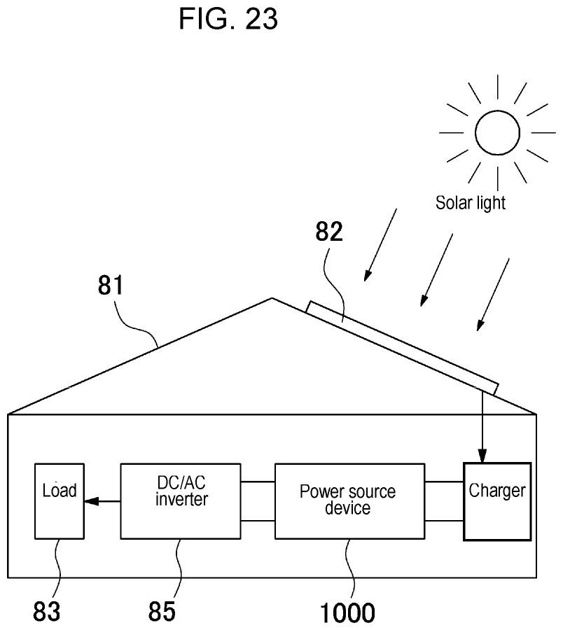

The present invention will not limit application of the power source device only to a power source of a motor used to travel a vehicle. The power source device according to the present invention can be applied as a power source of a power storage system configured to charge batteries to store electric power with use of electric power generated through solar power generation, wind power generation, or the like. FIG. 23 depicts a power storage system configured to charge the batteries in power source device 1000 to store electric power with use of a solar battery. As depicted in FIG. 23, the power storage system is configured to charge the batteries in power source device 100 with electric power generated by solar battery 82 disposed on a roof or a top of building 81 as a house, a plant, or the like. The power storage system is configured to supply, via DC/AC inverter 85, load 83 with electric power stored in power source device 100.

Though not depicted, the power source device may alternatively be applied as a power source of a power storage system configured to charge batteries with midnight power to store electric power. The power source device configured to be charged with midnight power is charged using midnight power as excess power of a power plant and outputs electric power during daytime having a large electric power load to limit peak power during daytime. The power source device can still alternatively be applicable as a power source configured to be charged with both output power of a solar battery and midnight power. The power source device effectively uses both electric power generated by the solar battery and midnight power to efficiently store electric power in consideration of weather and power consumption.

The power storage system described above is suitably applied as a backup power source device mountable on a rack of a computer server, a backup power source device for a wireless base station of mobile phones, a power source for storage at home or at a plant, a power storage apparatus combined with a solar battery to be applied as a power source for street lights or the like, and a backup power source for traffic lights or road traffic indicators.

### INDUSTRIAL APPLICABILITY

The present invention provides a battery device most appropriately applied to a vehicle power source device configured to supply electric power to a vehicle motor requiring high power, or a power storage apparatus configured to store natural energy or midnight power.

### REFERENCE MARKS IN THE DRAWINGS

100, 200, 300, 400, 500, 600, 1000: power source device
1: battery cell
1X: terminal surface
1a: outer can
1b: sealing plate
2: electrode terminal
2a: projection
2b: welding surface
3, 23, 33, 43, 53, 63: bus bar
3k: opening
4, 24, 34, 44, 54, 64: branched connection part
34X, 54X: first branched connection part
34Y, 54Y: second branched connection part
34x, 34y: parallel connection line
34M, 54M: intermediate part
5, 25, 35, 45, 55, 65: series connection line
5A: main series connection line
5B: sub series connection line
25a, 35a: welding part
25b, 35b: stepped part
6, 26, 36, 46, 56, 66: terminal connection part
6A, 6B, 26A, 26B, 66A, 66B: terminal connection part
6a, 26a, 36a, 46a, 56a, 66a: terminal hole
7, 27, 37, 47, 57, 67: multiple connection part
27A, 27B, 47A, 67A: branched part
27M, 47M: intermediate part
8, 28, 48, 58, 68: buffer
8a: groove
28a, 58a, 68b: curved part
48a, 48b, 48c, 68a, 68c: bent part
9, 29, 39, 49, 59, 69: parallel battery group
10, 20, 30, 40, 50, 60: battery stack
13: fixture
14: end plate
15: fastener
16: insulating spacer
17: end surface spacer
18: insulating material
19: insulating gap
21, 31, 41, 61: first metal plate
22, 32, 42, 62: second metal plate
81: building
82: solar battery
83: load
85: DC/AC inverter
91: vehicle body
93: motor
94: power generator
95: DC/AC inverter
96: engine
97: wheel
101, 201: battery cell
102, 202: electrode terminal
103, 203A, 203B: bus bar
104: through hole
110, 210: battery stack
205: cut-away part
HV: vehicle
EV: vehicle

1. A power source device comprising:
a battery stack configured by stacking a plurality of battery cells each provided with positive and negative electrode terminals; and
a bus bar connected to the electrode terminals of the plurality of battery cells to connect the plurality of battery cells in parallel and in series, the plurality of battery cells being connected in parallel and in series via the bus bar,
wherein
the bus bar includes
a series connection line connecting in series parallel battery groups each including the plurality of battery cells connected in parallel, and
a branched connection part branched and connected to each of both ends of the series connection line,
the electrode terminals of the plurality of battery cells configuring each of the parallel battery groups are connected to the branched connection part to allow the battery cells configuring each of the parallel battery groups to be connected in parallel via the branched connection part, and
the battery cells connected in parallel via the branched connection part in the parallel battery groups are connected in series via the series connection line.

2. The power source device according to claim 1, wherein
the bus bar includes a plurality of series connection lines, and
the series connection lines have both ends connected to each other, and a plurality of the branched connection parts is connected to the both ends of the series connection lines connected to each other.

3. The power source device according to claim 2, wherein the bus bar includes two of the series connection lines.

4. The power source device according to claim 1, wherein
the branched connection parts each includes a plurality of terminal connection parts connected to the electrode terminals of the battery cells, and a multiple connection part connecting the terminal connection parts,
the both ends of the series connection line are each connected to the multiple connection part, and
the multiple connection part is branched and connected to the plurality of terminal connection parts.

5. The power source device according to claim 1, wherein
the branched connection part includes
a first branched connection part having a plurality of terminal connection parts connected to the electrode terminals of the battery cells, and a multiple connection part connecting the terminal connection parts, and
a second branched connection part having both ends connected to the multiple connection part of the first branched connection part and an intermediate part connected to the series connection line, and
the plurality of battery cells connected in parallel via the first branched connection part is connected in parallel via the second branched connection part to configure each of the parallel battery groups.

6. The power source device according to claim 5, wherein the second branched connection part is configured by a metal plate thicker than the terminal connection part, and the series connection line is configured by a metal plate lager in transverse sectional area than the second branched connection part.

7. The power source device according to claim 4, wherein the terminal connection part is configured by a metal plate thinner than the series connection line.

8. The power source device according to claim 1, wherein
the series connection line is configured by a first metal plate, and the branched connection part is configured by a second metal plate, and
the first metal plate has each end connected to the second metal plate and each of the ends of the series connection line is connected to the branched connection part.

9. The power source device according to claim 8, wherein
the first metal plate includes a plurality of series connection lines having both ends connected, and
the first metal plate has each end connected to the second metal plate.

10. The power source device according to claim 8, wherein the first metal plate is disposed in a vertical posture or a horizontal posture.

11. The power source device according to claim 8, wherein the first metal plate is thicker than the second metal plate.
